(19) United States
(12) Patent Application Publication
(10) Pub. No.: US 2025/0021540 A1
(43) Pub. Date: Jan. 16, 2025

(54) METHODS AND SYSTEMS THAT AUTOMATICALLY SEGREGATE INFRASTRUCTURE-AS-CODE DATA INTO CATEGORY-ASSOCIATED FILES

(71) Applicant: VMWARE, LLC, Palo Alto, CA (US)

(72) Inventors: PRIYANK AGARWAL, Bangalore (IN); Deepansha Goyal, Bangalore (IN); Praveen Kumar, Bangalore (IN); Suchitha Shet, Bangalore (IN); Vijay Chauhan, Bangalore (IN)

(21) Appl. No.: 18/381,662

(22) Filed: Oct. 19, 2023

Related U.S. Application Data
(63) Continuation-in-part of application No. 18/380,661, filed on Oct. 17, 2023.

(30) Foreign Application Priority Data
Jul. 12, 2023 (IN) 202341046773
Aug. 4, 2023 (IN) 202343052630

(51) Int. Cl. G06F 16/22; G06F 16/16; G06F 16/27

(52) U.S. Cl. CPC G06F 16/2272; G06F 16/164; G06F 16/27

(57) ABSTRACT

The current document is directed to an infrastructure-as-code (“IaC”) cloud-infrastructure-management service or system that automatically segregates resource descriptors into category-associated files. In a first mode of operation, an automatic segregator receives one or more raw specification-and-configuration files and partitions the resources specified in the one or more raw specification-and-configuration files into category-associated resource groups. The specifications for the resources that are then stored in category-associated files that may, in turn, be stored in category-associated subdirectories of a file-system directory. In a second mode of operation, the automatic segregator transforms a first type of specification-and-configuration files within a first file-system directory into a second type of equivalent specification-and-configuration files within a second file-system directory.

### CROSS-REFERENCE TO RELATED APPLICATION

This application is a Continuation-in-part of patent application Ser. No. 18/380,661 entitled “METHODS AND SYSTEMS THAT AUTOMATICALLY GENERATE PARAMETERIZED CLOUD-INFRASTRUCTURE TEMPLATES”, filed on Oct. 17, 2023, which claims the benefit under 35 U.S.C. 119(a)-(d) to Foreign Application Serial No. 202341046773 filed in India entitled “METHODS AND SYSTEMS THAT AUTOMATICALLY GENERATE PARAMETERIZED CLOUD-INFRASTRUCTURE TEMPLATES”, on Jul. 12, 2023 and Indian Application number 202343052630 entitled “METHODS AND SYSTEMS THAT AUTOMATICALLY SEGREGATE INFRASTRUCTURE-AS-CODE DATA INTO CATEGORY-ASSOCIATED FILES” filed on Aug. 4, 2023, by VMware, Inc., which is herein incorporated in its entirety by reference for all purposes.

### TECHNICAL FIELD

The current document is directed to distributed-computer-systems and, in particular, to an infrastructure-as-code (“IaC”) cloud-infrastructure-management service or system that automatically segregates resource descriptors into category-associated files.

### BACKGROUND

During the past seven decades, electronic computing has evolved from primitive, vacuum-tube-based computer systems, initially developed during the 1940s, to modern electronic computing systems, including distributed cloud-computing systems, in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including distributed service-oriented applications. Distributed applications, including distributed service-oriented applications and distributed microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications have, in turn, become increasingly complex, involving greater computational overheads and significant inefficiencies and deficiencies. In fact, many desired management-and-administration functionalities are becoming sufficiently complex to render traditional approaches to the design and implementation of automated and semi-automated management and administration subsystems impractical, from a time and cost standpoint. Therefore, designers and developers of distributed computer systems and applications continue to seek new approaches to implementing automated and semi-automated management-and-administration facilities and functionalities.

### SUMMARY

The current document is directed to an infrastructure-as-code (“IaC”) cloud-infrastructure-management service or system that automatically segregates resource descriptors into category-associated files. In a first mode of operation, an automatic segregator receives one or more raw specification-and-configuration files and partitions the resources specified in the one or more raw specification-and-configuration files into category-associated resource groups. The specifications for the resources that are then stored in category-associated files that may, in turn, be stored in category-associated subdirectories of a file-system directory. In a second mode of operation, the automatic segregator transforms a first type of specification-and-configuration files within a first file-system directory into a second type of equivalent specification-and-configuration files within a second file-system directory.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates a number of different cloud-computing facilities that provide computational infrastructure to an organization for supporting the organization's distributed applications and services.

FIG. 9 illustrates a universal-management-interface provided by the currently disclosed IaC cloud-infrastructure-management service.

FIG. 10 illustrates the architecture of the currently disclosed IaC cloud-infrastructure-management service.

FIG. 11 illustrates the cloud-management interface provided by the currently disclosed IaC cloud-infrastructure-management service.

FIG. 12 illustrates components of a GraphQL API interface.

FIGS. 13A-14E illustrate an example schema, an extension to that example schema, and queries, a mutation, and a subscription to illustrate the GraphQL data query language.

FIG. 15 illustrates a stitching process.

FIGS. 16A-D illustrate the YAML Ain′t Markup Language (“YAML”) data serialization language.

FIG. 17 illustrates certain features provided by the Jinja template engine that are used, in addition to YAML, for representing infrastructure in SLS documents.

FIGS. 18A-C illustrate a structured labor state (“SLS”) data file and credential file as well as the output from an Idem describe command.

FIG. 19 illustrates a fundamental control loop involving the Idem service.

FIG. 20 illustrates one implementation of the Idem service.

FIG. 21

FIG. 22

FIG. 23

FIG. 24

FIG. 25

FIG. 26

FIGS. 27A-B

FIG. 28

FIGS. 29A-G

FIG. 30

FIG. 31

FIG. 32

FIGS. 33A-D

FIGS. 34A-B

FIG. 35

FIG. 36

FIG. 37

### DETAILED DESCRIPTION

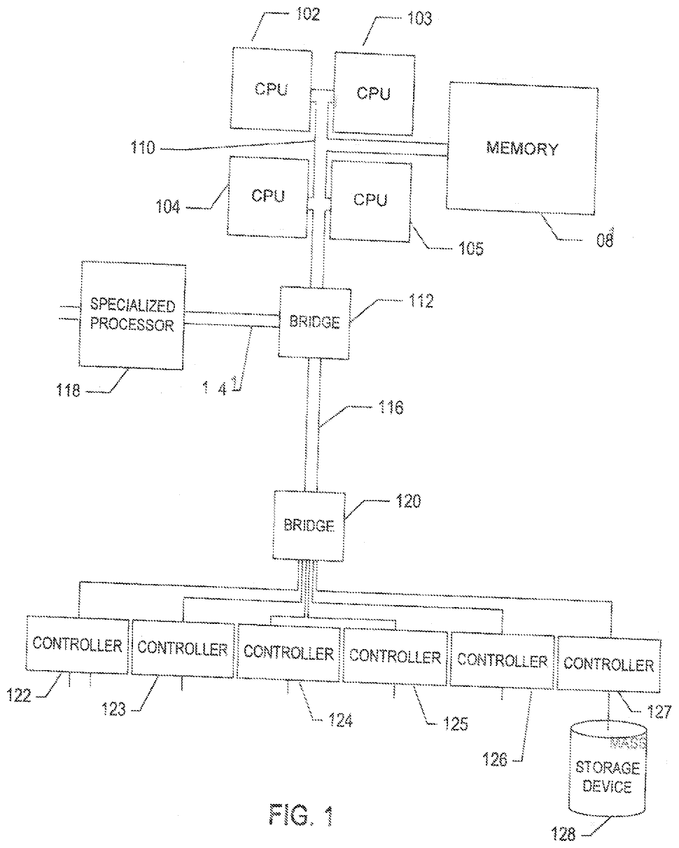

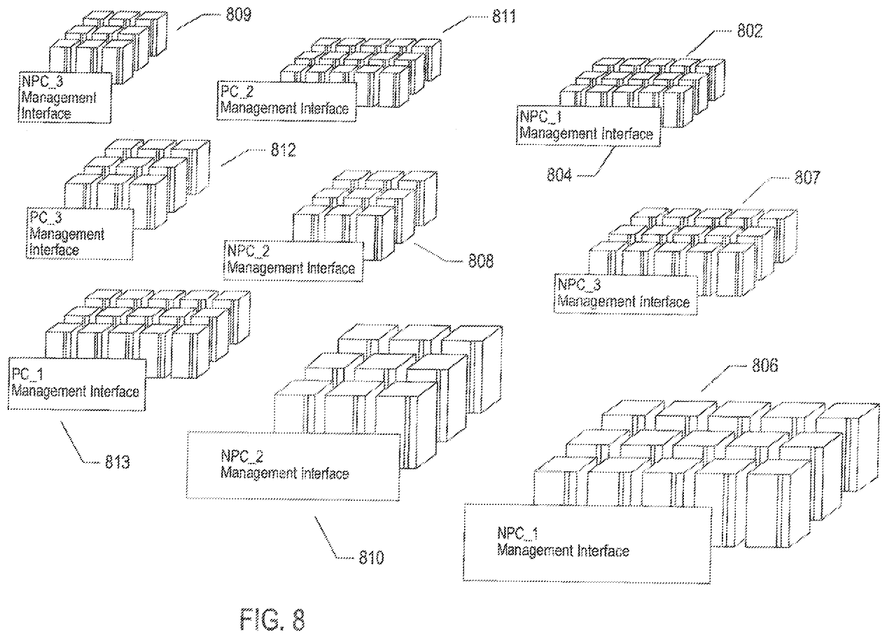

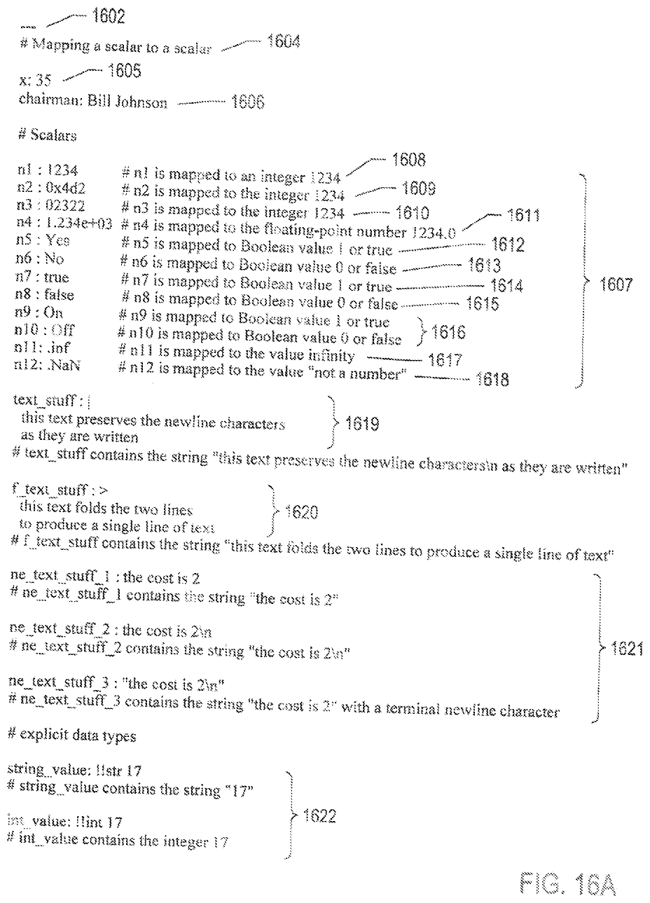

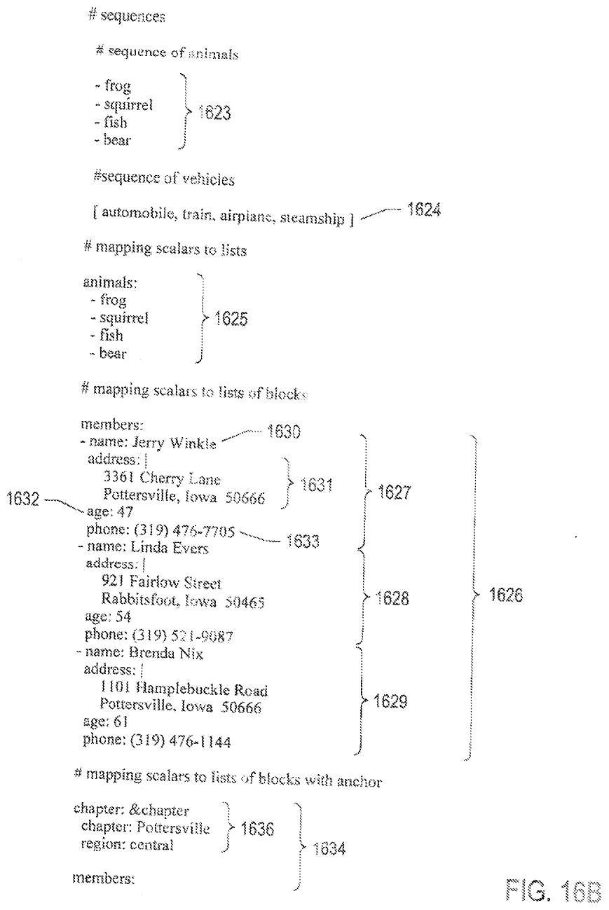

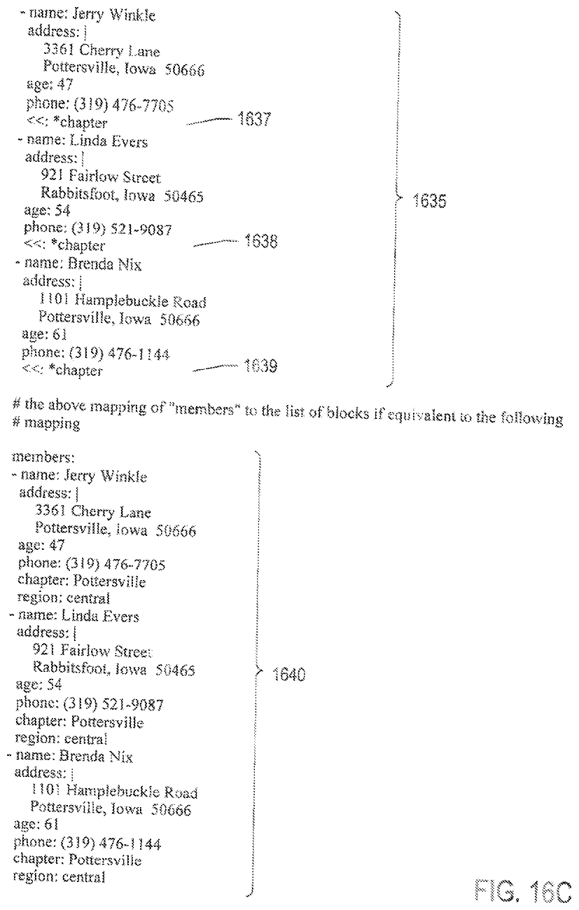

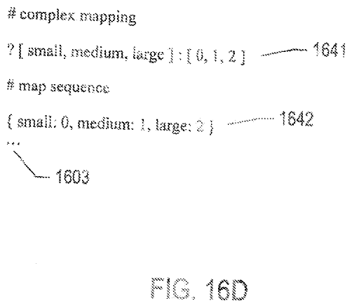

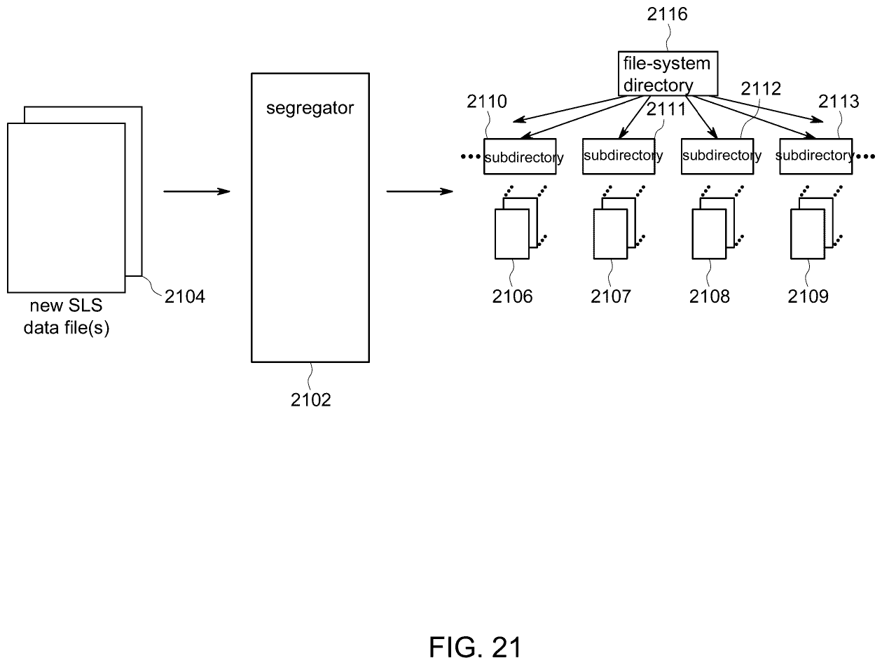

The current application is directed to an infrastructure-as-code (“IaC”) cloud-infrastructure-management service or system that automatically segregates resource descriptors into category-associated files. In a first subsection, below, a detailed description of computer hardware, complex computational systems, and virtualization is provided with reference to FIGS. 1-7. In a second subsection, an overview of the currently disclosed IaC cloud-infrastructure-management service is provided, with reference to FIGS. 8-11. A third subsection provides an overview of the GraphQL API interface with reference to FIGS. 12-15. A fourth subsection provides an overview of YAML, JINJA, and SLS documents and the Idem service and system, with reference to FIGS. 16-20. Finally, in a fifth subsection, the currently disclosed methods and systems are discussed with reference to FIGS. 21-37.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

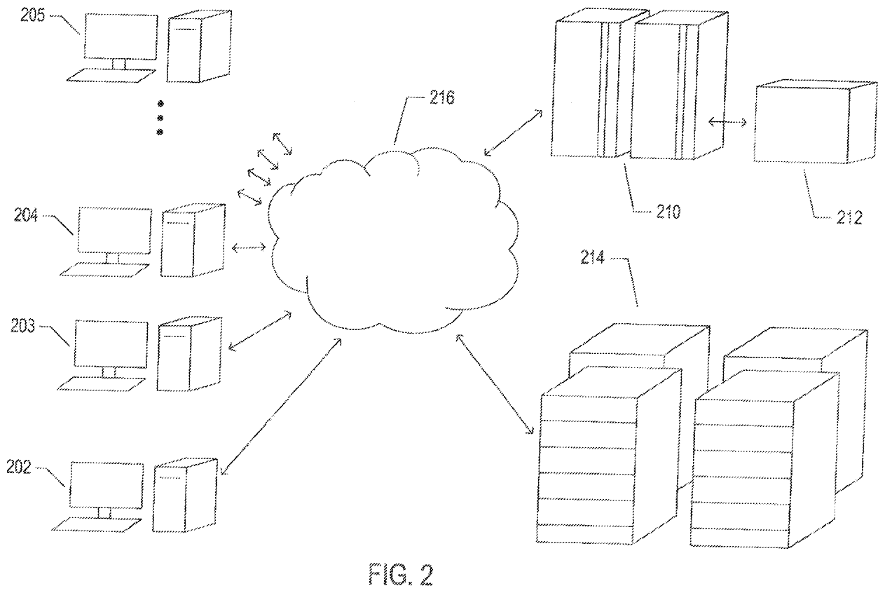

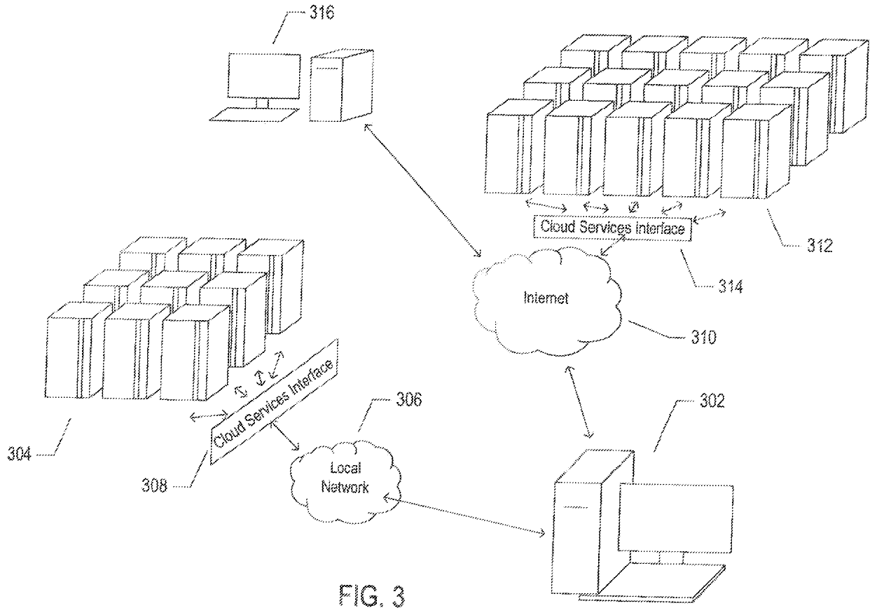

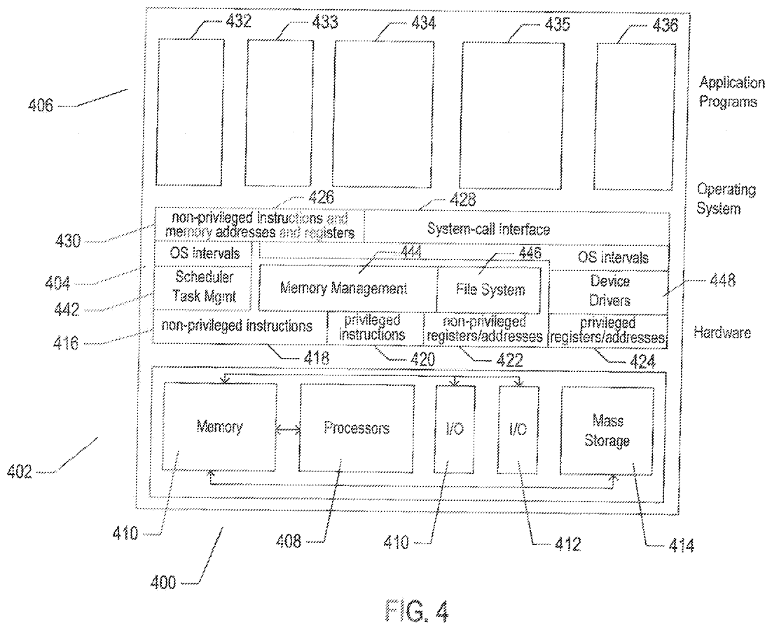

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

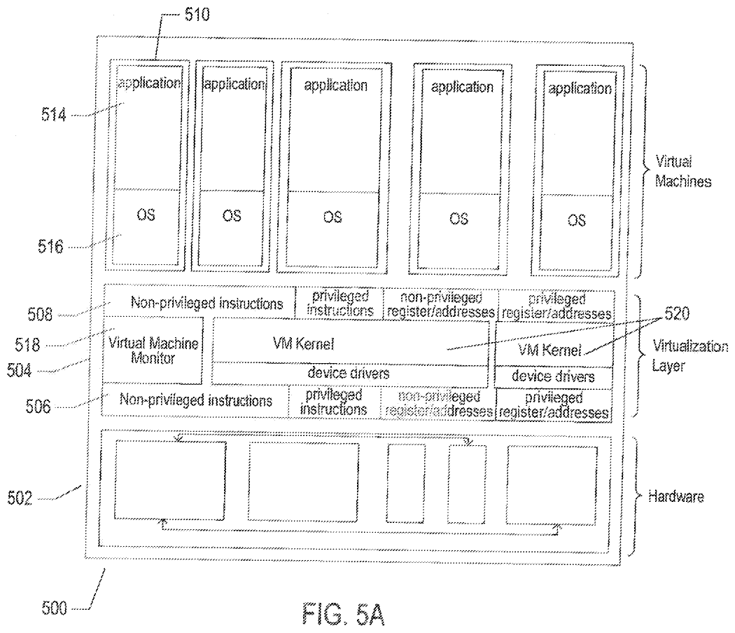

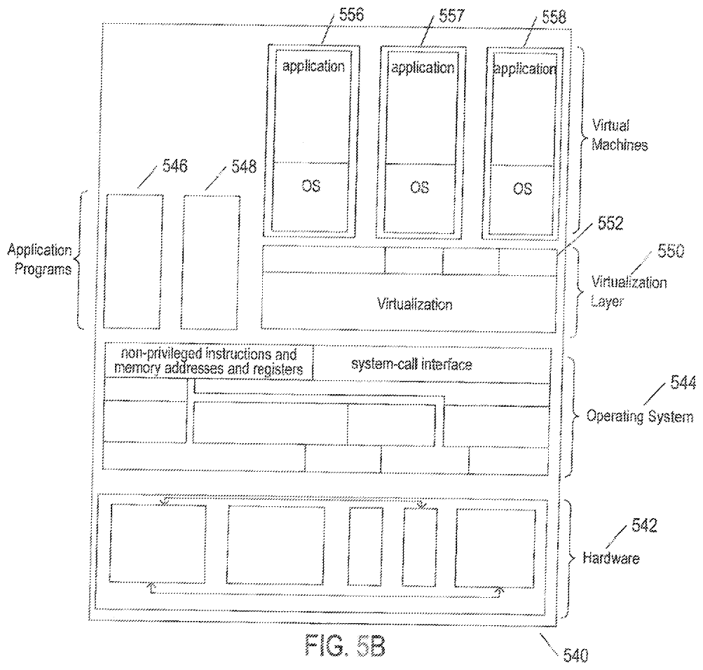

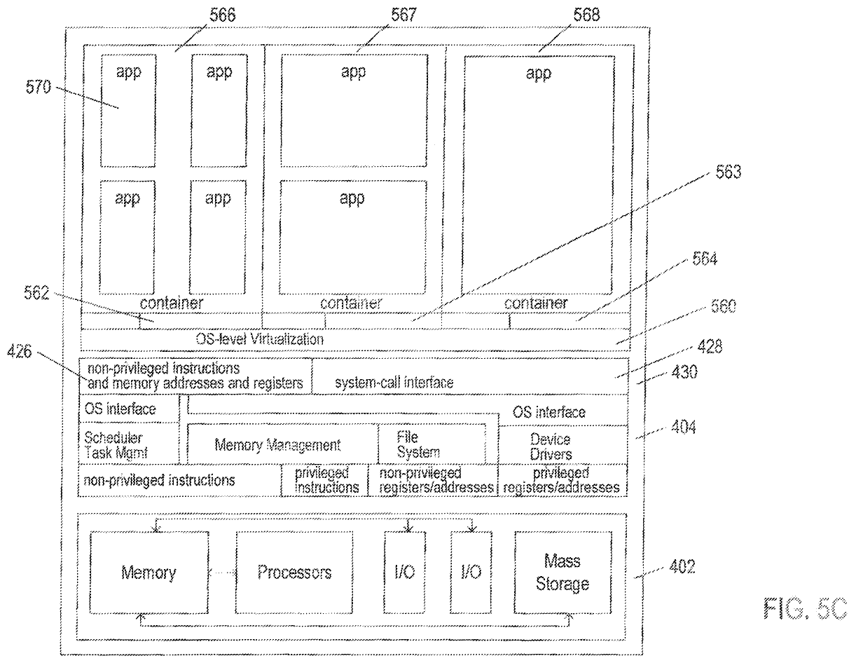

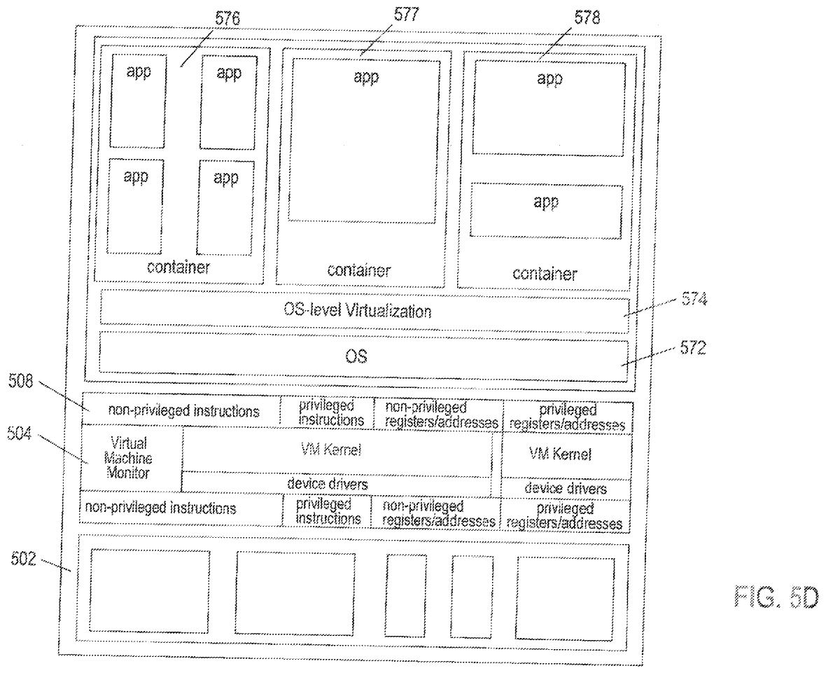

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

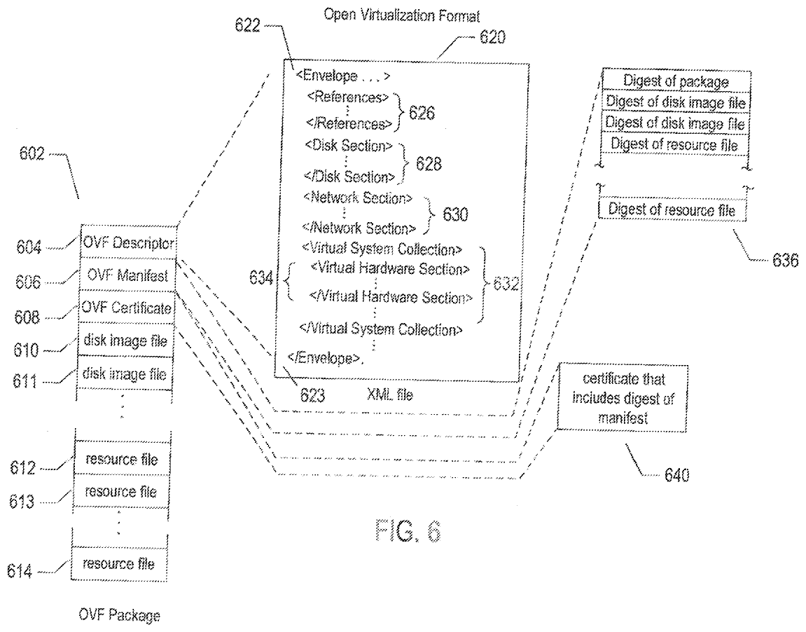

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

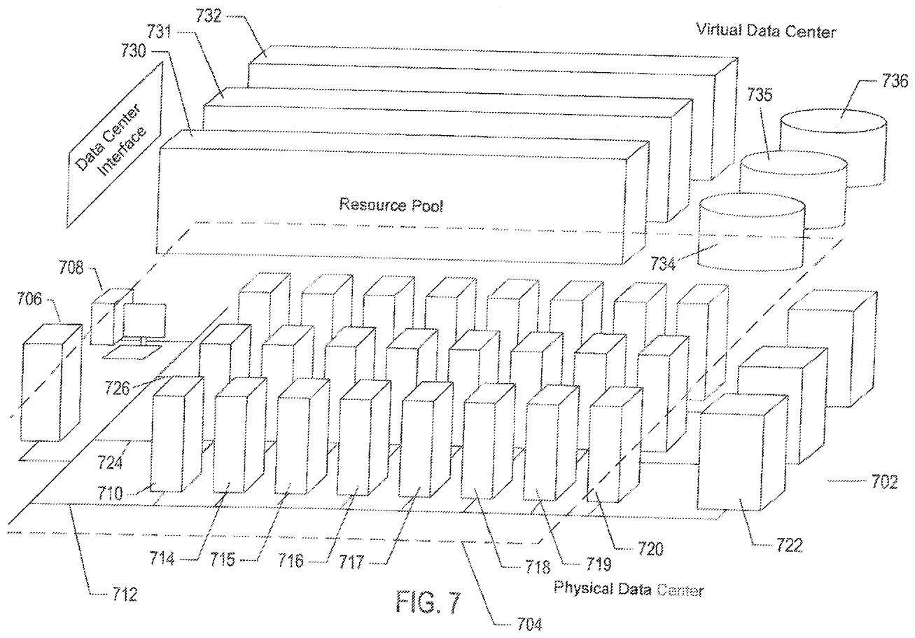

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

### Overview of a IaC Cloud-Infrastructure-Management Service

FIG. 8 illustrates a number of different cloud-computing facilities that provide computational infrastructure to an organization for supporting the organization's distributed applications and services. The cloud-computing facilities are each represented by an array of cabinets containing servers, data-storage appliances, communications hardware, and other computational resources, such as the array of cabinets 802. Each cloud-computing facility provides a management interface, such as management interface 804 associated with cloud-computing facility 802. The organization leases computational resources from a number of native-public-cloud cloud-computing facilities 802 and 806-810 and also obtains computational resources from multiple private-cloud cloud-computing facilities 811-813. The organization may wish to move distributed-application and distributed-service instances among the cloud-computing facilities to take advantage of favorable leasing rates, lower communications latencies, and desirable features and policies provided by particular cloud-computing facilities. In addition, the organization may wish to scale-up or scale-down the computational resources leased from different cloud-computing facilities in order to efficiently handle dynamic workloads. All of these types of operations involve issuing commands and requests through the management interfaces associated with the cloud-computing facilities. In the example shown in FIG. 8, cloud-computing facilities 802 and 806 are accessed through a first type of management interface, cloud-computing facilities 808 in 810 are accessed through a second type of management interface, and cloud-computing facilities 807 and 809 are accessed through a third type of management interface. The management interfaces associated with private-cloud cloud-computing facilities 811-813 are different from one another and from the native-public-cloud management interfaces.

The many different management interfaces represent a challenge to management and administration personnel within the organization. The management personnel need to be familiar with a variety of different management interfaces that may involve different command sets, different command-set syntaxes, and different features. In addition, the different management interfaces may accept different types of blueprints or cloud templates that specify the infrastructure and infrastructure configuration desired by the organization. It may be difficult for management personnel to determine whether certain desired features and functionalities easily accessed and obtained through certain types of management interfaces are even provided by cloud-computing facilities associated with other types of management interfaces. Different management interfaces may require different types of authentication and authorization credentials which further complicates management operations performed by management and administration personnel. These problems may even be of greater significance when computational resources are leased from cloud-computing facilities and configured and managed by automated management systems.

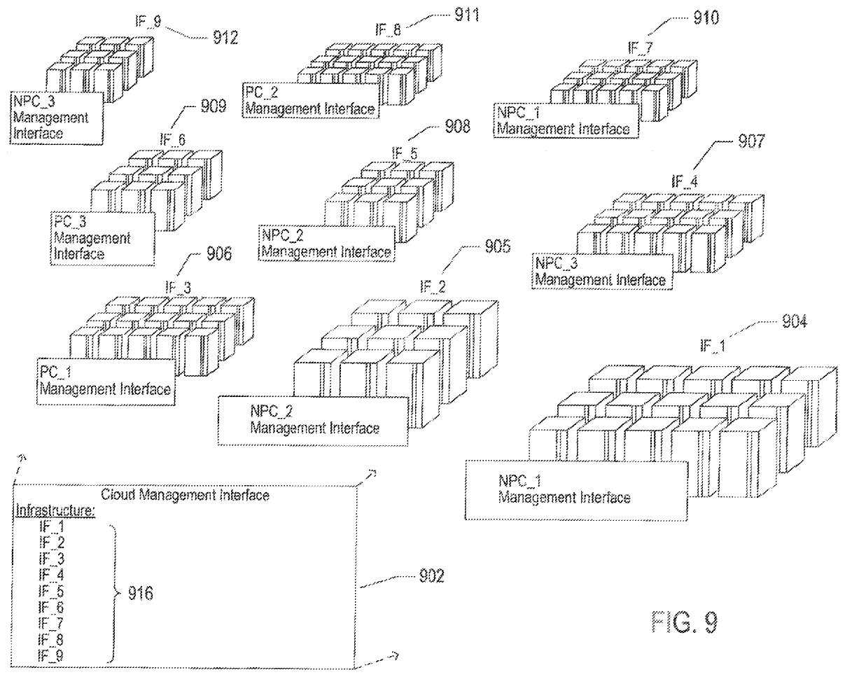

To address the problems associated with multiple different management interfaces to multiple different cloud-computing facilities, discussed in the preceding paragraph, a currently described IaC cloud-infrastructure-management service provides a single, universal management interface through which management and administration personnel as well as automated management systems define and deploy cloud-based infrastructure within many different types of cloud-computing facilities. FIG. 9 illustrates a universal-management-interface provided by the currently disclosed IaC cloud-infrastructure-management service. The currently described IaC cloud-infrastructure-management service provides a cloud-management interface 902 through which both human management personnel and automated management systems can manage computational infrastructure provided by many different types of underlying cloud-computing facilities associated with various different types of management interfaces. The infrastructure deployed and configured within the various cloud-computing facilities is represented in FIG. 9 by the labels “IF_1” 904, “IF_2” 905, “IF_3” 906, “IF_4” 907, “IF_5” 908, “IF_6” 909, “IF_7” 910, “IF_8” 9011, and “IF_9” 912. The currently described IaC cloud-infrastructure-management service maintains the required authentication and authorization credentials for the different underlying cloud-computing facilities on behalf of human management personnel and automated management systems and automatically provides the required authentication and authorization credentials when accessing management interfaces provided by the different underlying cloud-computing facilities. One or more common types of cloud templates or blueprints are used to specify desired infrastructure and desired infrastructure configuration within the underlying cloud-computing facilities. Each different set of computational resources that together constitute an infrastructure within each of the cloud-computing facilities is visible, and can be managed, through the cloud-management interface 902, as indicated by the infrastructure labels 916 shown within the cloud-management interface.

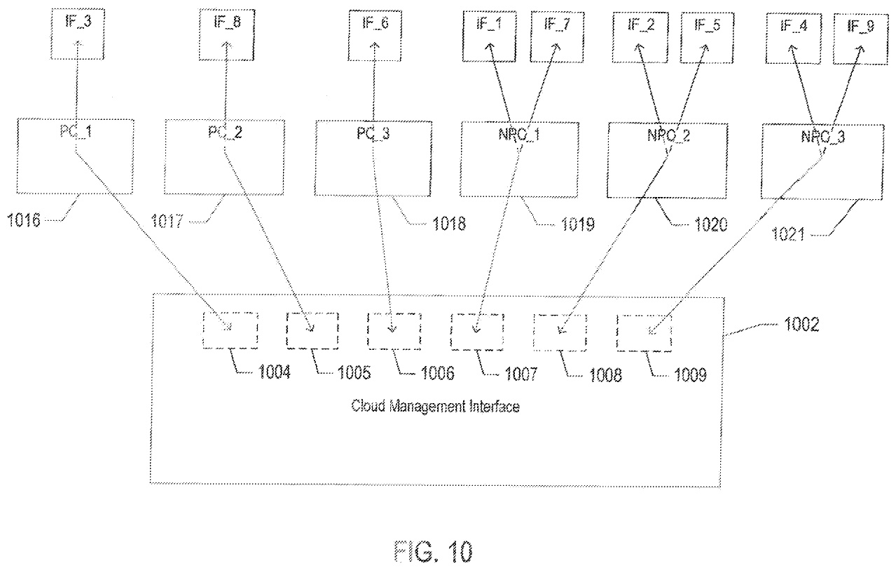

FIG. 10 illustrates the architecture of the currently described IaC cloud-infrastructure-management service. The IaC cloud-infrastructure-management service provides a cloud-management interface 1002 that includes a common or universal set of commands that can be used to deploy and configure infrastructure in many different types of private-cloud and native-public-cloud cloud-computing facilities that provide various types of cloud-management interfaces, allowing management and administration personnel and upstream automated infrastructure-management systems to deploy and configure infrastructure across the many different types of cloud-computing facilities through a common cloud-management interface 1002. The cloud-management interface 1002 is implemented by the IaC cloud-infrastructure-management service, discussed below. The IaC cloud-infrastructure-management service includes cloud-computing-facility-specific plug-ins, represented by dashed-line rectangles 1004-1009, that implement, together with control logic within the IaC cloud-infrastructure-management service, translation of the commands and features of the cloud-management interface 1002 to the commands and features of the underlying cloud-facility-specific management interfaces 1016-1021.

FIG. 11 illustrates the cloud-management interface provided by the currently described IaC cloud-infrastructure-management service. The cloud-management interface 902 includes four different GraphQL application programming interfaces (“APIs”): (1) Submit Task 1102, through which deployment-and-configuration commands are input to the IaC cloud-infrastructure-management service; (2) Query Task 1103, through which status queries for previously submitted deployment-and-configuration commands and requests are input to the IaC cloud-infrastructure-management service; (3) Validate SLS 1104, through which requests to validate SLS data are input to the IaC cloud-infrastructure-management service; and (4) Retrieved Schema 1105, through which the schemas for infrastructures within underlying computing-facilities can be requested from the IaC cloud-infrastructure-management service. Requests and commands input to the IaC cloud-infrastructure-management service are generally accompanied with an authorization/authentication/role certificate or token 1110, deployment-and-configuration tasks submitted to the Submit Task API are generally accompanied with SLS data 1112 (described below), and requests for validation of SLS data are accompanied with the SLS data to be validated, as indicated by curved arrows, such as curved arrow 1114, in FIG. 11. The schema 1116 returned when a command input to the Retrieve Schema API is executed is convertible into an SLS-data specification 1118 which can be input to the Submit Task API and/or modified and input to the Submit Task API.

There are, however, many different types of IaC cloud-infrastructure-management service or system implementations. For example, an IaC cloud-infrastructure-management service or system may be alternatively implemented as a collection of plug-ins that together comprise a cloud-infrastructure-management engine and a command-line interface (“CLI”). It is, for this reason, that the current document uses the phrase “service or system” to indicate that the currently described IaC cloud-infrastructure-management service is but one implementation approach to implementing cloud-infrastructure-management. To avoid repeating this phrase, the phrase “cloud-infrastructure manager” is used to refer to the various possible implementations of the currently described IaC cloud-infrastructure-management service or system.

### GraphQL Interface

FIG. 12 illustrates components of a GraphQL interface. The GraphQL interface is used as an API interface by various types of services and distributed applications. For example, as shown in FIG. 12, a server 1202 provides a service that communicates with a service client 1204 through a GraphQL API provided by the server. The service client 1204 can be viewed as a computational process that uses client-side GraphQL functionality 1206 to allow an application or user interface 1208 to access services and information provided by the server 1202. The server uses server-side GraphQL functionality 1210, components of which include a query processor 1212, a storage schema 1214, and a resolver component 1216 that accesses various different microservices 1218-1223 to execute the GraphQL-encoded service requests made by the client to the server. Of course, a GraphQL API may be provided by multiple server processes in a distributed application and may be accessed by many different clients of the services provided by the distributed application. GraphQL provides numerous advantages with respect to the Representational State Transfer (“REST”) interface technology, including increased specificity and precision with which clients can request information from servers and a potential for increased data-transfer efficiencies.

FIGS. 13A-E illustrate an example schema, an extension to that example schema, and queries, a mutation, and a subscription to illustrate the GraphQL query language. The example shown in FIGS. 13A-E does not illustrate all of the different GraphQL features and constructs, but a comprehensive specification for the GraphQL query language is provided by the GraphQL Foundation. A GraphQL schema can be thought of as the specification for an API for a service, distributed application, or other server-side entity. The example schema provided in FIGS. 13A-B is a portion of a very simple interface to a service that provides information about shipments of drafting products from a drafting-product retailer.

Three initial enumeration datatypes are specified in a first portion of FIG. 13A. The enumeration BoxType 1302 specifies an enumeration datatype with four possible values: “CARDBOARD,” “METAL,” “SOFT_PLASTIC,” and “RIGID_PLASTIC.” In the example schema, a box represents a shipment and the box type indicates the type of container in which the shipment is packaged. The enumeration ProductType 1304 specifies an enumeration datatype with eight possible values: “PENCIL_SET,” “ERASER_SET,” “INK_SET,” “PEN_SET,” “INDIVIDUAL_PENCIL,” “INDIVIDUAL_ERASER,” and “INDIVIDUAL_INK,” “INDIVIDUAL_PEN.” In the example schema, a shipment, or box, can contain products including sets of pencils, erasers, ink, and pens as well as individual pencils, erasers, ink, and pens. In addition, as discussed later, a shipment, or box, can also contain one or more boxes, or sub-shipments. The enumeration SubjectType 1306 specifies an enumeration datatype with four possible values: “PERSON,” “BUILDING,” “ANIMAL,” and “UNKNOWN.” In the example schema, the subject of a photograph is represented by one of the values of the enumeration SubjectType.

The interface datatype Labeled 1308 is next specified in the example schema. An interface datatype specifies a number of fields that are necessarily included in any object datatype that implements the interface. An example of such an object datatype is discussed below. The two fields required to be included in any object datatype that implements the interface Labeled include: (1) the field id 1309, of fundamental datatype ID; and (2) the field name 1310, of fundamental datatype String. The symbol “!” following the type specifier “ID” is a wrapping type that requires the field id to have a non-null value. The fundamental scalar datatypes in GraphQL include: (1) integers, Int; (2) floating-point values, Float; (3) Boolean values, Boolean; (4) string values, String; and (5) identifiers, ID. All of the more complex datatypes in GraphQL must ultimately comprise scalar datatypes, which can be thought of as the leaf nodes of a parse tree generated from parsing GraphQL queries, mutations, and subscriptions, discussed below. Wrapping datatypes include the non-null wrapping datatype discussed above and the list wrapping datatype indicated by bracketing a datatype, such as “[Int],” which specifies a list, or single-dimensional array, of integers or “[[Int]],” which specifies a list of lists or a two-dimensional matrix of integers.

The union Item 1312 is next specified in the example schema. A union datatype indicates that a field in an output data object can have one of the multiple datatypes indicated by the union specification. In this case, the datatype Item can be either a Box data object or a Product data object.

The Box object datatype 1314 is next specified in the example schema. An object datatype is a collection of fields that can have scalar-data-type values, wrapping-data-type values, or object data-type values. Because an object datatype may include one or more fields with object data-type values, object datatypes can describe hierarchical aggregations of data. The language “implements Labeled” 1315 indicates that the Box object datatype necessarily includes the interface Labeled fields id and name, discussed above, and those fields occur as the first two fields 1316 of the Box object datatype. The fields id and name represent a unique identifier and a name for the shipment represented by an instance of the Box object datatype. The additional fields in the Box object datatype include: (1) length 1317, of type Float, representing the length of the shipment container; (2) height 1318, of type Float, representing the height of the shipment container; (3) width 1319, of type Float, representing the width of the shipment container; (4) weight 1320, of type Float, representing the weight of the shipment container; (5) boxType 1321, of non-null enumeration type boxType, representing the type of shipment container; (6) contents 1322, an array of non-null Item data objects, representing the contents of the shipment; and (7) numItems 1323, of type Int, representing the number of items in the array contents. Since the field contents is an array of Item data objects, a box, or shipment, can contain one or more additional boxes, or sub-shipments. This illustrates how the GraphQL query language supports arbitrarily hierarchically nested data aggregations.

Turning to FIG. 13B, the example schema next specifies a Product 1326 object datatype that, like the Box object datatype, implements the interface Labeled and that additionally includes a field pType 1327 of enumeration type ProductType. An instance of the Product object datatype represents one of the different types of products that can be included in the shipment.

The example schema next specifies a custom scalar datatype ImageURL 1328 to store a Uniform Resource Locator (“URL”) for an image. The language “@specifiedByo” is a directive that takes a URL argument that references a description of how a String serialization of the custom scalar datatype ImageURL needs to be composed and formatted in order to represent a URL for an image. GraphQL supports a number of built-in directives and allows for specification of custom directives. Directives are essentially specifications of run-time execution details that are carried out by a server-side query processor that processes GraphQL queries, mutations, and subscriptions, discussed below. As another example, built-in directives can control query-execution to omit or include certain fields in returned data objects based on variables evaluated at the query-execution time. It should also be noted that fields in object datatypes may also take arguments, since fields are actually functions that return the specified datatypes. Arguments supplied to fields, like arguments supplied to directives, are evaluated and used at query-execution time by query processors.

The example schema next specifies the Photo object datatype 1330, which represents a photograph or image that can be accessed through the service API specified by the schema. The Photo object datatype includes fields that represent the name of the photo, and image size, the type of subject of the photo or image, and in image URL.

The example schema next specifies three queries, a mutation, and a subscription for the root Query, Mutation, and Subscription operations. A query, like a database query, requests the server-side GraphQL entity to return information specified by the query. Thus, a query is essentially an information request, similar to a GET operation on a REST API. A mutation is a request to alter stored information and is thus similar to a PUT or PATCH operation on a REST API. In addition, a mutation returns requested information. A subscription is a request to open a connection or channel through which a GraphQL client receives specified information as the information becomes available to the GraphQL server that processes the subscription request. Thus, the various data objects specified in the schema provide the basis for constructing queries, mutations, and subscriptions that allow a client to request and receive information from a server. The example schema specifies three different types of queries 1332 that can be directed, by a client, to the server via the GraphQL interface: (1) getBox 1334, which receives an identifier for a Box data object as an argument and returns a Box data object in response; (2) getBoxes 1335, which returns a list or array of Box data objects in response; and (3) getPhoto 1336, which receives the name of a photo or image as an input argument and returns a Photo data object in response. These are three examples of the many different types of queries that might be implemented in the GraphQL interface. A single mutation addProduct 1338 is specified, which receives the identifier for a Box data object and a product type as arguments and, when executed by the server, adds a product of the specified product type to the box identified by the Box data-object identifier and returns a Product data object representing the product added to the box. A single subscription getBoxUpdates receives a list of Box data-object identifiers, as an argument, and returns a list of Box data objects in each response returned through the communications channel opened between the client and server for transmission of the requested information, over time, to the client. In this case, the client receives Box data objects corresponding to any of the boxes specified in the argument to the subscription getBoxUpdates when those Box data objects are updated, such as in response to addProduct mutations submitted to the server.

Finally, the example schema specifies two fragments: (1) boxFields 1342; and (2) productFields 1344. A fragment specifies one or more fields of an object datatype. Fragments can be used to simplify query construction by expanding a fragment, using the operator “ . . . ” in a selection set of a query, mutation, or subscription, as discussed below, rather than listing each field in the fragments separately in the selection set. A slightly different use of fragments is illustrated in example queries, below. In the current case, the fragment boxFields includes only the single field name of the Box data-object type and the fragment productFields includes only the single field name pType of the Product datatype.

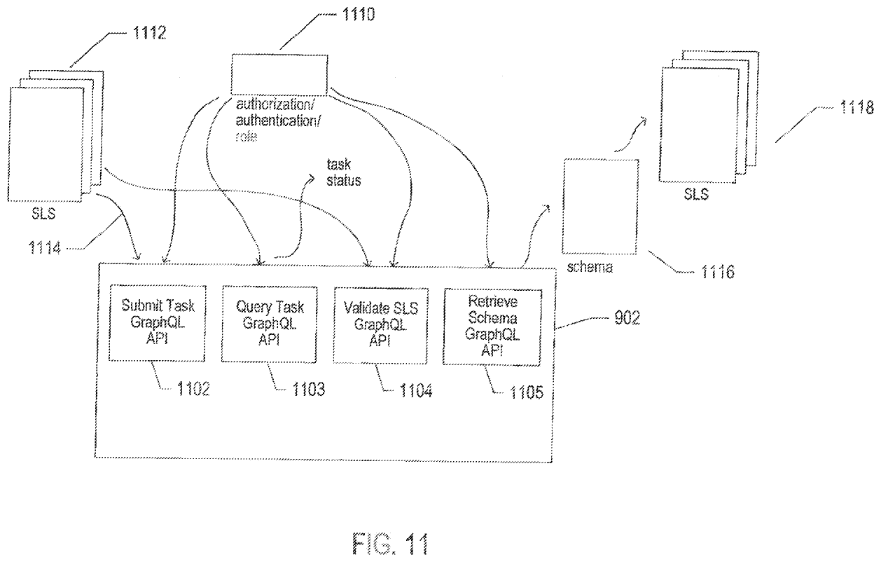

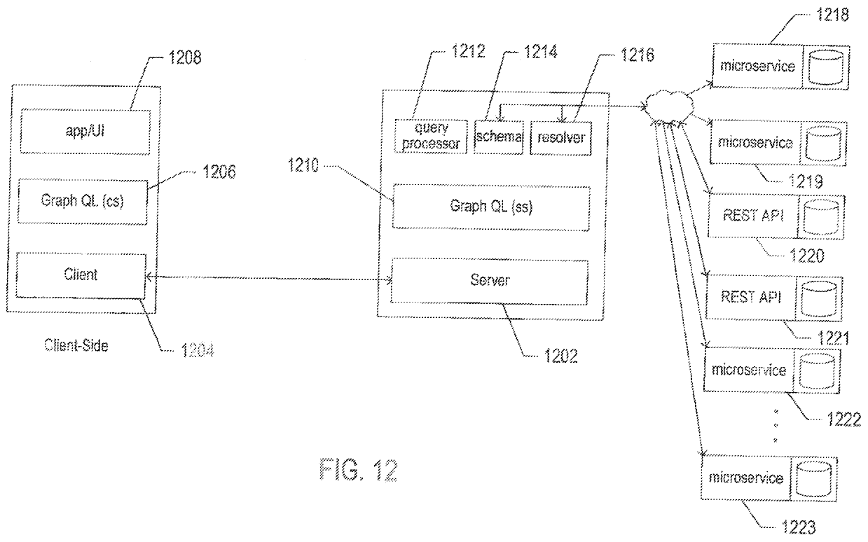

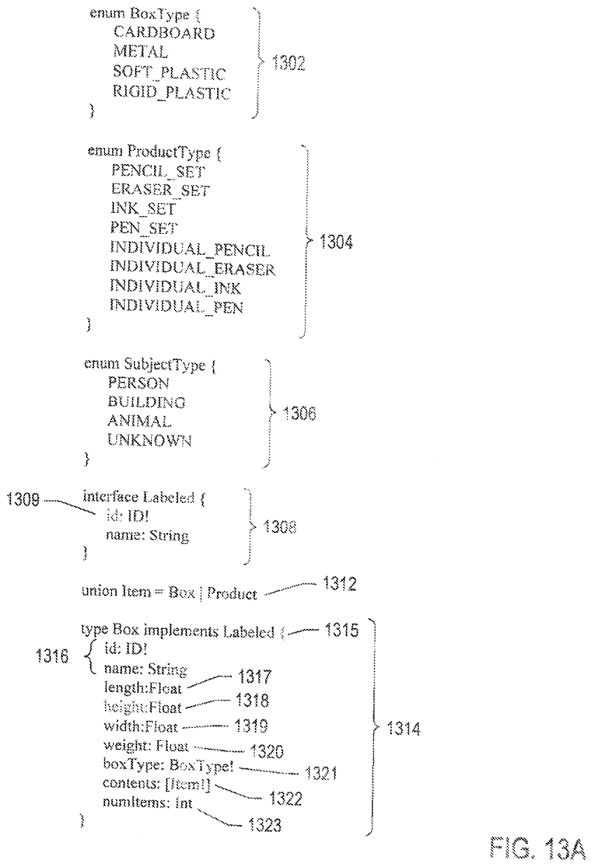

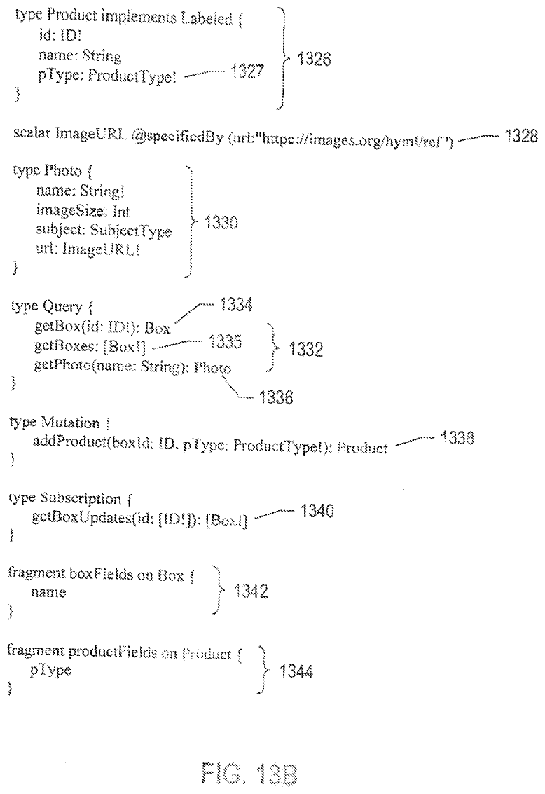

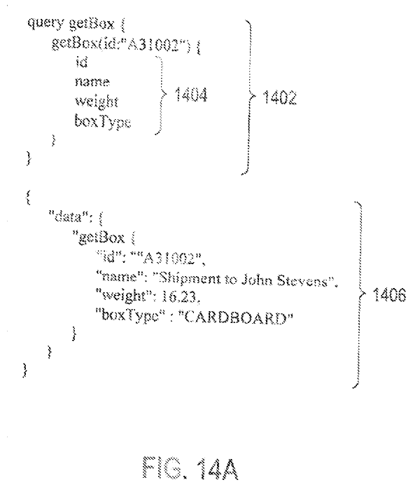

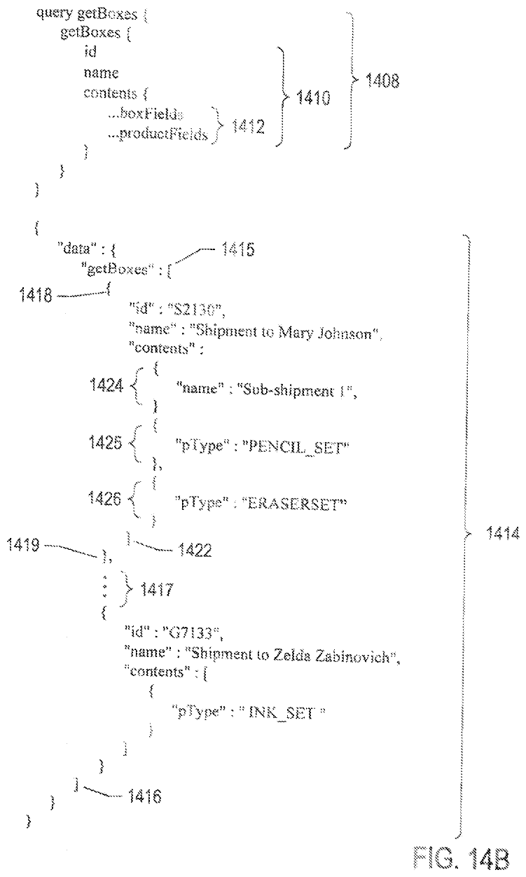

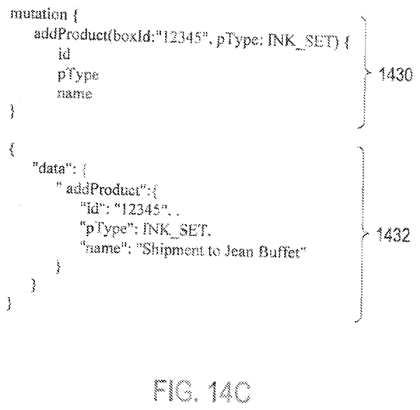

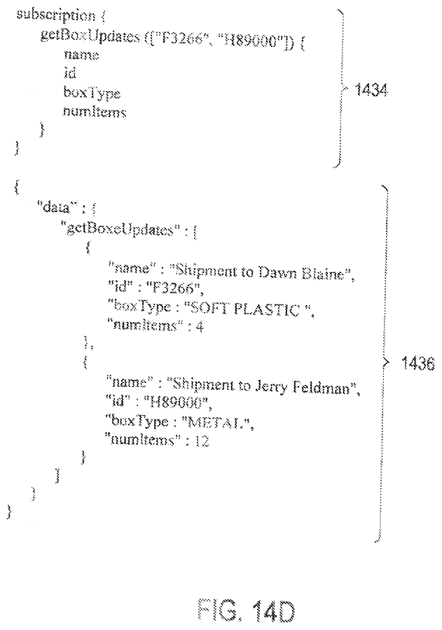

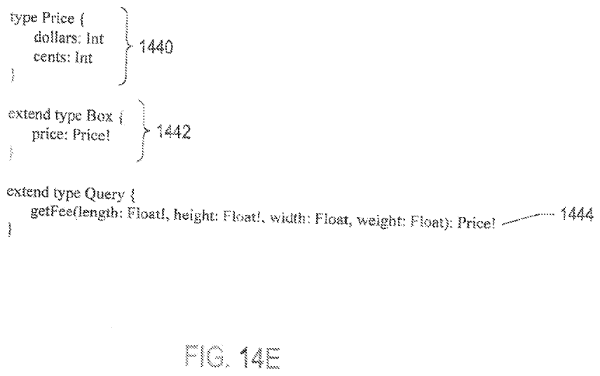

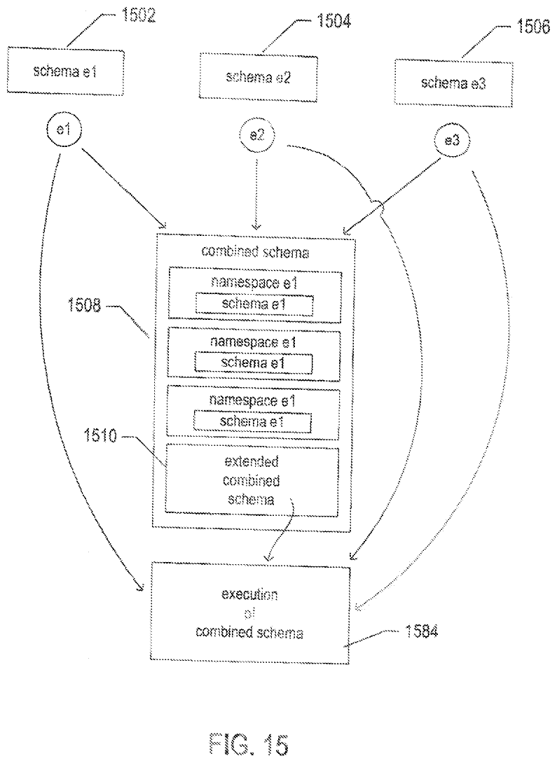

FIGS. 14A-D illustrates two example queries, an example mutation, and an example subscription based on the example schema discussed with reference to FIGS. 13A-B. FIG. 14A shows an example query 1402 submitted by a client to a server and the JavaScript Object Notation (“JSON”) data object returned by the server to the client. Various different types of data representations and formats can be returned by servers implementing GraphQL interfaces, but JSON is a commonly used data representation and formatting convention. The query 1402 is of the query type 1334 specified in FIG. 13B. The argument specified for the query is “A31002,” the String serialization of a Box identifier. A selection set 1404 for the query specifies that the client issuing the query wishes to receive only values for the id, name, weight, and boxType fields of the Box data object with identifier “A31002.” The JSON response to the query 1406 contains the requested information. This points to one of the large advantages provided by the GraphQL query language. A client can specify exactly the information the client wishes to receive from the server, rather than receiving predefined information for predefined queries provided by a REST interface. In this case, the client is not interested in receiving values for many of the fields in the Box data object and is able to use a selection set in the query to request only those fields that the client is interested in receiving.

FIG. 14B illustrates a second example query based on the example schema discussed with reference to FIGS. 13A-B. The second example query 1408 is of the query type 1335 specified in FIG. 13B. A selection set 1410 within the query requests that, for each Box data object currently maintained by the server, values for the id, name, and contents fields of the Box data object should be returned. The contents field has a list type and specifies a list of Item data objects, where an Item may be either a Box data object or a Product data object. A selection set 1412 for the contents field uses expansion of the boxFields and productFields fragments to specify that, for each Item in the list of Item data objects represented by the contents field, if the Item is a Box data object, then the value of the name field for that Box data object should be returned while, if the Item is a Product data object, then the value of the pType field of the Product data object should be returned. The JSON response 1414 to query 1408 is shown in the lower portion of FIG. 14B. The returned data is a list of the requested fields of the Box data object currently maintained by the server. That list begins with bracket 1415 and ends with bracket 1416. Ellipsis 1417 indicates that there may be additional information in the response for additional Box data objects. The requested data for the first Box data object occurs between curly brackets 1418 and 1419. The list of items for the contents of this Box data object begin with bracket 1420 and end with bracket 1422. The first Item 1424 in the list is a Box data object and the second two Item data objects 1425 and 1426 are Product data objects. The second example query illustrates that a client can receive a large amount of arbitrarily related information in one request-response interaction with a server, rather than needing to use multiple request-response interactions. In this case, a list of portions of multiple Box data objects can be obtained in one request-response interaction. As another example, in a typical REST interface, a client may need to submit a request to separately retrieve information for each Box data object contained within an outer-level Box data object, but, using a hierarchical object datatype, that information can be requested in a single GraphQL query.

FIG. 14C illustrates an example mutation based on the example schema discussed with reference to FIGS. 13A-B. The example mutation 1430 is of the mutation type 1338 specified in FIG. 13B. The mutation requests that the server add a product of type INK_SET to the Box data object identified by Box data-object identifier “12345” and return values for the id, pType, and name fields of the updated Box data object. The JSON response 1432 to query 1430 is shown in the lower portion of FIG. 14C. FIG. 14D illustrates an example subscription based on the example schema discussed with reference to FIGS. 13A-B. The example subscription 1434 is of the subscription type 1340 specified in FIG. 13B. The subscription requests that the server return, for updated Box data objects identified by Box data-object identifiers “F3266” and “H89000,” current values for the name, id, boxType, and numItems fields. One of the JSON responses 1436 to subscription 1434 returned at one point in time is shown in the lower portion of FIG. 14D.

FIG. 14E illustrates a second schema, based on the first example schema of FIGS. 13A-B and generated by extending the first example schema. The second schema may be used as an interface to a different service that returns shipment fees associated with Box data objects that represent shipments. The schema extension includes specification of a new Price data object 1440, extension of the object datatype Box to include an additional field price with a Price data-object value 1442, and extending the root Query operation type to include a getFee query 1444 that receives the length, height, width, and weight of a shipment and returns the corresponding shipment price or cost. Thus, GraphQL provides for extension of schemas to generate new extended schemas to serve as interfaces for new services, distributed applications, and other such entities.

FIG. 15 illustrates a stitching process. Schema stitching is not formally defined by the GraphQL query-language specification. The GraphQL query-language specification specifies that a GraphQL interface is represented by a single schema. However, in many cases, it may be desirable to combine two or more schemas in order to produce a combined schema that is a superset of the two or more constituent schemas, allowing queries, mutations, and subscriptions based on the combined schema to employ object datatypes and other defined types and directives specified in two or more of the constituent schemas. There are multiple different types of implementations of schema stitching. In an example shown in FIG. 15, there are three underlying schemas 1502-1504. The stitching process combines these three schemas into a combined schema 1508. The combined schema includes the underlying schemas. In the illustrated approach to stitching, each underlying schema is embedded in a different namespace in the combined schema, which may include additional extensions 1510. The namespaces are employed in order to differentiate between identical identifiers used in two or more of the underlying schemas. Other approaches to stitching may simply add extensions to all or a portion of the type names defined in all of the underlying schemas in order to generate unique names across all of the underlying schemas. In the combined schema, queries, mutations, and subscriptions may use types from all of the underlying schemas and, in combined-schema extensions of underlying-schema types, a type defined in one underlying schema can be extended to reference a type defined in a different underlying schema. When a query, mutation, or subscription defined in the combined schema is executed, the execution 1514 may involve execution of multiple queries by multiple different services associated with the underlying schemas.

### YAML/JINJA and SLS Data

FIGS. 16A-D illustrate the YAML Ain′t Markup Language (“YAML”) data serialization language. YAML provides for representing data in text files. Certain features of YAML are illustrated by the YAML document shown in FIGS. 16A-D. A YAML document begins with three hyphens (1602 in FIG. 16A) and ends with three periods (1603 in FIG. 16D.) Multiple YAML documents can be included in a single text file. Comments begin with a “#” symbol followed by a space, such as the comment 1604. One of the fundamental constructs in YAML is a mapping of a scalar value to a scalar string, or name, such as the mapping 1605 of the integer value 35 to the name “x” and the mapping 1606 of the string value “Bill Johnson” to the name “Chairman.” YAML supports a variety of different types of scalars, as shown in the set of mappings 1607, including: integers encoded as decimal integers 1608, integers encoded as hexadecimal integers 1609, and integers encoded as octal integers 1610; floating-point numbers 1611; Boolean values “Yes” 1612 and “No” 1613, “true” 1614 and “false” 1615, and “On” and “Off” 1616; a value representing infinity 1617; and a value representing “not a number” 1618. On lines 1619, two text lines are mapped to the name “text_stuff,” with the symbol “I” used to indicate that newline characters in the text should be preserved. On lines 1620, two text lines are mapped to the name “f_text_stuff,” with the symbol “>” indicating that newlines should be removed in order to fold the text into a single text block. Text can be unquoted or quoted, as indicated by the examples on lines 1621. The “!!” operator can be used to explicitly assign types to values, as indicated on lines 1622.

Turning to FIG. 16B, another fundamental data structure supported by YAML is the sequence or list. Several different representations of lists are supported. In a first representation of a list 1623, the elements of the list are indicated by a preceding “-” and a space. In a second representation 1624, the elements of the list are contained within brackets and separated by commas and spaces. As indicated on lines 1625, a list can be mapped to a name. In the example of lines 1625, a list of animals is mapped to the character string, or name, “animals.” Note that indentation is used, as in the Python programming language, to indicate hierarchical structure.

Lines 1626 show a mapping of a more complex type of list to the name, or character string, “members.” In this example, the list is a list of blocks 1627-1629. Each block is preceded by a hyphen and a space. Each block contains a mapping of a character string to the character string “name” 1630, a mapping of two text lines to the character string “address” 1631, a mapping of an integer to the character string “age” 1632, and a mapping of an alphanumerically encoded phone number to the character string “phone” 1633. In the example of lines 1634 at the bottom of FIG. 16B and lines 1635 at the top of FIG. 16C, the mapping of the list of blocks to the character string “members” on lines 1626 of FIG. 16B is modified to include two additional lines in each block of the list. The two additional lines are specified using the anchor symbol “&” on lines 1636 at the bottom of FIG. 16B. The lines are included at the end of each block in the list using the reference prefix “<<: *” at the beginning of each of three lines referencing the anchor “chapter” 1637-1639. The modified list is equivalent to the list shown on lines 1640 of FIG. 16C. Finally, on line 1641 at the top of FIG. 16D, a more complex mapping that maps the list “[0, 1, 2]” to the list “[small, medium, large]” is shown. This mapping can alternatively be represented by the map sequence, or dictionary, shown on line 1642. The example YAML document shown in FIG. 16A-D does not, of course, provide a comprehensive description of the YAML data-representation language, but is instead intended to show some of the main features and constructs of YAML that are used in SLS documents, discussed below.

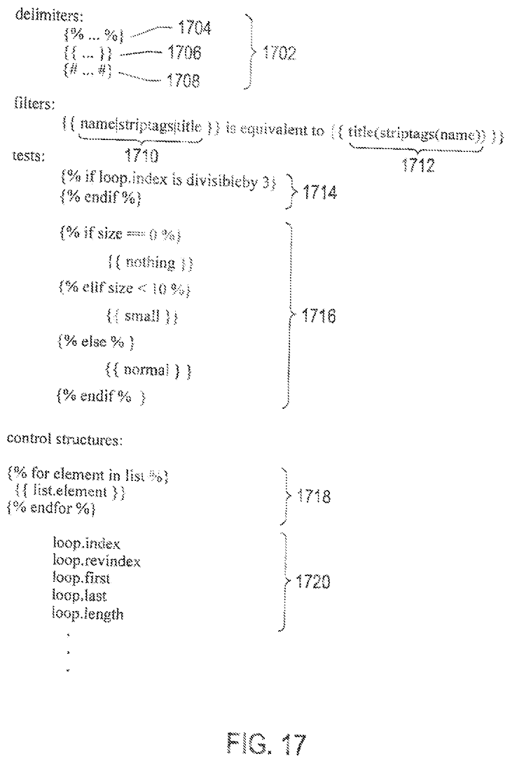

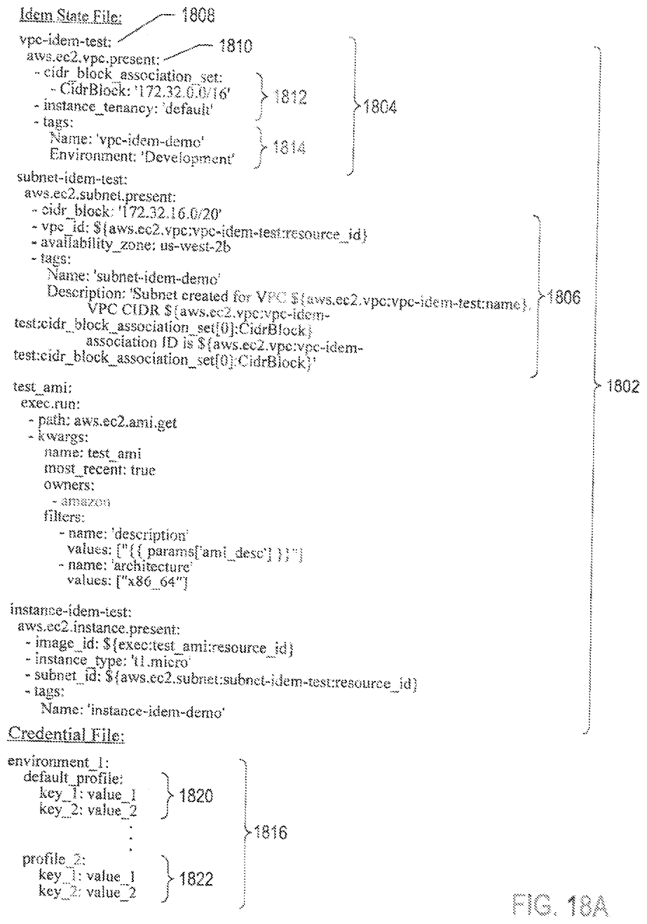

FIG. 17 illustrates certain features provided by the Jinja template engine that are used, in addition to YAML, for representing infrastructure in SLS documents. Jinja employs several types of delimiters to encode Jinja constructs. These are shown on lines 1702 of FIG. 17, with ellipses indicating that additional text is enclosed by the delimiters. A first type of delimiter 1704 is used to encapsulate tests, control structures, and other programming-language-like constructs. A second type of delimiter 1706 is used to encapsulate variables for output. A third type of delimiter 1708 is used to enclose comments. Pipe symbols “|” can be used to indicate sequences of function calls. For example, the delimited string “namelstriptagsltitle” 1710 is equivalent to the character string 1712, which represents calling a function “title” with an argument that represents a value returned by calling the function “striptags” with the argument “name.” Jinja supports if statements, as shown by the example on lines 1714, and if-elseif-else statements, as shown by the example on lines 1716. Jinja provides a set of comparison operators used in if and if-elseif-else statements. Finally, Jinja provides various types of control structures, such asfor-loops, as indicated on lines 1718. The for-loop control structure is accompanied with a number of Jinja loop variables 1720 that can be used in conditional expressions within loops. FIG. 17 does not provide a comprehensive list of examples of Jinja features and constructs, but is instead intended simply to show some of the main types of Jinja constructs that, in combination with YAML constructs and features, are used in SLS documents, described below.

The currently described cloud-infrastructure-management service is referred to as the “Idem service” in the remainder of this document, for reasons discussed in a following section. The Idem service, as discussed above, receives SLS data files that describe deployment and configuration of cloud-based infrastructure. SLS data files can be represented in various different data-serialization languages, including JSON, but a combination of YAML-like and Jinja-like formatting conventions, features, and constructs are most frequently used. An Idem state file is an SLS data file that represents configuration of a cloud-based infrastructure, and Idem SLS data files serve as blueprints or cloud templates input to the Submitted Task and Validate SLS APIs of the Idem-service management interface. There are, however, many different types of Idem implementations. Idem may be considered to be a data flow programming language, for example, and an Idem system may be implemented as a collection of plug-ins that together comprise a cloud-infrastructure-management engine and a command-line interface (“CLI”). In the current document, the Idem service introduced, above with reference to FIGS. 9-11, is used as an example cloud-infrastructure-management system in which the currently described automated methods for generating parameterized cloud templates corresponding to already deployed and configured cloud infrastructure can be incorporated, but the currently described automated methods can alternatively be incorporated in other types of Idem implementations.

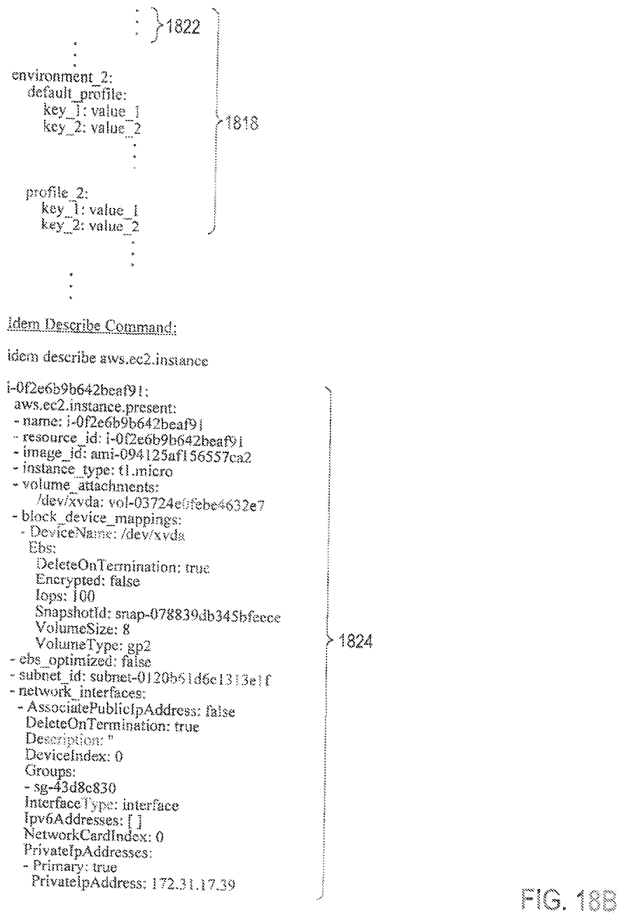

FIGS. 18A-C illustrate a structured layered state (“SLS”) data file and an SLS credential file as well as the output from an Idem describe command. A simple, example Idem state file is shown in the initial portion 1802 of FIG. 18A. The example SLS state file creates a virtual private cloud (“VPC”) for a virtual machine within an AWS cloud-computing facility and connects the VPC to an AWS subnet. A first portion of the example SLS state file 1804 specifies the VPC and a second portion of the example SLS state file 1806 specifies the subnet. Each resource includes a state name, such as “vpc-item-test” 1808 for the VPC, and a directive, or function, such as “aws.ec2.vpc.present” 1810. Directives include: (1) present, which indicates that, when the resource is not currently present in the infrastructure, the resource should be allocated, deployed, and configured according to the resource specification and that, when the resource is currently present in the infrastructure, the Idem service resource should ensure that the current deployment and configuration of the resource corresponds to the resource specification; (2) absent, which indicates that, when the resource is currently allocated and deployed, the resource should be removed; and (3) describe, which requests that the Idem service return information about the resource. Resources are specified using a plug-in/resource-group/resource-type tuple, such as “aws.ec2.vpc” in directive 1810. The plug-in portion of the plug-in/resource-group/resource-type tuple refers to a plug-in associated with a particular cloud-computing facility or cloud provider which provides the executables for accessing the particular cloud-computing facility and/or a set of cloud-computing facilities managed by the cloud provider. A resource specification includes a list of attribute/value pairs, generally including property/value pairs 1812 tag/value pairs 1814. Of course, real-world Idem state files may contain descriptions of hundreds or thousands of resources and, in addition, a blueprint or cloud templates may include multiple hierarchically organized SLS state files. The resource-group portion of the plug-in/resource-group/resource-type tuple refers to a group or class containing multiple types of resources and the resource-type portion of the plug-in/resource-group/resource-type tuple refers to a particular type of resource, such as a virtual machine or a subnet, which is a partition of the host-address space of a virtual-private-network-address space.

The form of an SLS credential file is shown in a lower portion 1816 of FIG. 18A and an upper portion 1818 of FIG. 18B. The SLS credential file contains a block of authentication/authorization information for one or more environments, each of which corresponds to plug-ins for different types of cloud-computing-facility management interfaces. The first portion 1816 of the example SLS credential file shown in FIG. 18A contains a block of authentication/authorization information for a first environment. Each block contains authentication/authorization information for one or more profiles, such as profiles 1820 and 1822 in the block for the first environment, including a default profile 1820. The authentication/authorization information is encoded as a set of attribute/value pairs, such as the name of a particular type of authentication/authorization information, such as an access key, and the alphanumerically encoded access key. SLS credential files are used to input authentication/authorization information to the Idem-service management interface so that the authentication/authorization information can be maintained by the Idem-service management interface and used by the Idem service to access functionality provided by the management interfaces of cloud-computing facilities via the various plug-ins.

The lower portion 1824 of FIG. 18B and the upper portion 1826 of FIG. 18C show the output of an Idem-service describe command executed with respect to the infrastructure described in the Idem state file 1802 shown in FIG. 18A. The output of the Idem-service describe command has a YAML-like format and can be used to generate a corresponding Idem state file that can be subsequently used to modify and enforce the configuration of the represented infrastructure, as discussed below. A final portion 1828 of FIG. 18C illustrates argument binding in SLS data files. The character string “${cloud: State_B: ID}” represents a reference to an attribute value of an attribute in an SLS data file generated by prior execution of a portion of an SLS data file. In the example shown in the final portion of FIG. 18C, the string “${cloud: State_B: ID}” references the name of the resource State_B once that name is obtained via an Idem-service state command. Moreover, execution of the Idem-service state command orders execution of operations related to specified resources to ensure that argument bindings refer to valid attribute values.

### Currently Disclosed Methods and Systems

As discussed above, the current application describes a cloud-infrastructure-management service referred to as the “Idem service.” This name is derived from the term “idempotent.” An idempotent operation is an operation that can be first applied to an object or entity and, when the object or entity is not subsequently altered by other operations, can be again applied to the object or entity without changing the object or entity. One example of an idempotent operation is the computational operation x=x mod 5, where the initial value of x is 16. The first application of the operation x=x mod 5 sets the value of x to 1. Provided that the value of x is not altered by some other operation, a second application of the operation x=x mod 5 results in the value of x remaining 1, and this is true for any number of repeated applications of the operation x=x mod 5 provided that the value of x is not altered by application of some other operation.

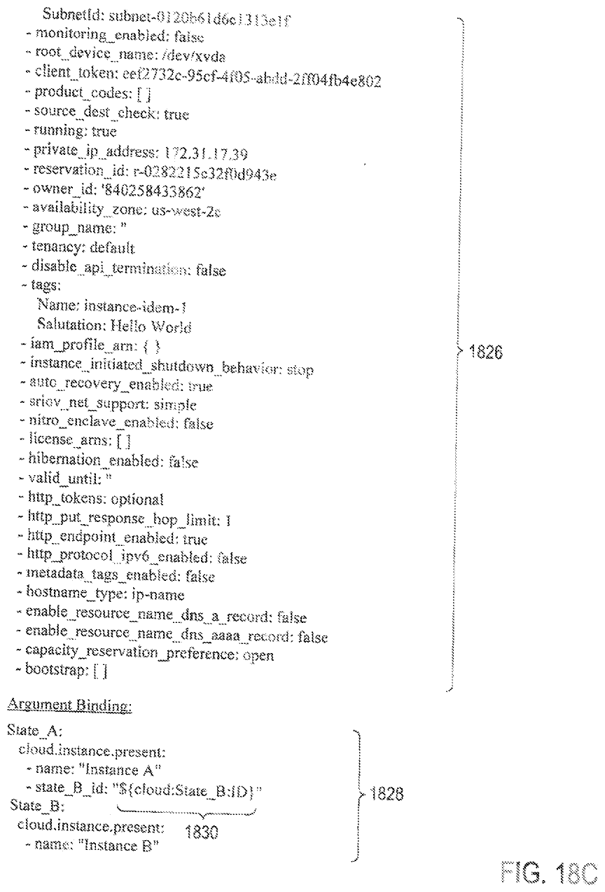

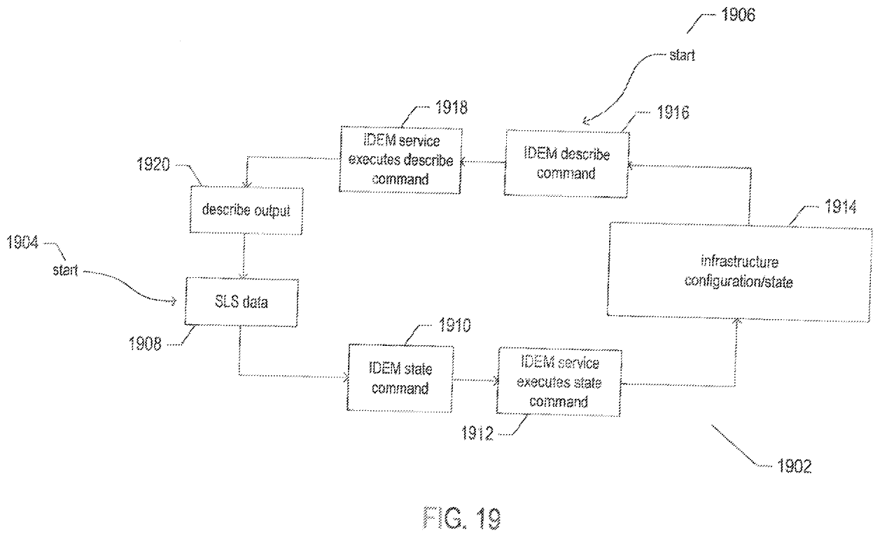

FIG. 19 illustrates a fundamental control loop involving the Idem service. This control loop involves the Idem-service state command, mentioned above, which applies an SLS-data blueprint or cloud template to a cloud-computing facility. In the case that no infrastructure has yet been deployed and configured within the cloud-computing facility on behalf of the individual or organization submitting the Idem-service state command to the management interface of the Idem service, the Idem service creates, deploys, and configures infrastructure on the cloud-computing facility according to the SLS-data blueprint or cloud template. When the resulting infrastructure is not subsequently altered by other commands or events, then, when the individual or organization again submits the same SLS-data blueprint or cloud template in a subsequent Idem-service state command to the management interface of the Idem service, the infrastructure is not changed by the subsequent Idem-service state command. However, in the case that the infrastructure has been altered by various events following the initial creation, deployment, and configuration of the infrastructure, submission of the same SLS-data blueprint or cloud template in a subsequent Idem-service state command to the management interface of the Idem service returns the infrastructure to the state that the infrastructure had upon initial creation, deployment, and configuration. Thus, the Idem-service state command associated with a particular SLS-data blueprint or cloud template is idempotent, and resubmission of an Idem-service state command associated with a particular SLS-data blueprint or cloud template can be used to control unintended departures of the state of cloud-based infrastructure, referred to as “enforcement,” without the risk of causing unintended changes to the state of the infrastructure defined by the SLS-data blueprint or cloud template.

The idempotency of the Idem-service state command is reflected in the fundamental control loop 1902 illustrated in FIG. 19. There are two possible starting points 1904 and 1906 for the control loop 1902. Assuming that the loop begins at the starting point 1904, the loop begins with an SLS-data blueprint or cloud template 1908 that describes desired infrastructure to be created, deployed, and configured within a cloud-computing facility. The SLS-data blueprint or cloud template is referenced by an Idem-service state command 1910 which is submitted to the Idem service for execution 1912. Execution of the Idem-service state command 1910 produces deployed and configured infrastructure 1914 with a state corresponding to a desired state represented by the SLS-data blueprint or cloud template. Subsequent submission of an Idem-service describe command 1916 result in execution of the describe command by the Idem service 1918 which, in turn, produces Idem-service-describe-command output 1920 that represents the current state of the infrastructure. At this point, if the output from the Idem describe command does not reflect the desired state of the infrastructure, the original SLS data can be referenced by a resubmitted Idem-service state command to enforce the originally desired infrastructure state. This enforcement operation is used to correct infrastructure drift, where “infrastructure drift” means an unintended departure of the state of the infrastructure from the desired state due to intervening events or operations. By contrast, if the loop started at starting point 1906, then the output from the Idem-service describe command can be translated into SLS data that can be subsequently used to enforce the infrastructure state represented by the SLS data. Yet another possibility is that the infrastructure state represented by the describe-command output may be used to generate corresponding SLS data which can then be modified in order to generate a new infrastructure state. Thus, the fundamental control loop may continue to iterate in order to maintain the state of the infrastructure in a desired state, with modifications to the SLS-data blueprint or cloud template made to alter the infrastructure state in response to changing goals or conditions.

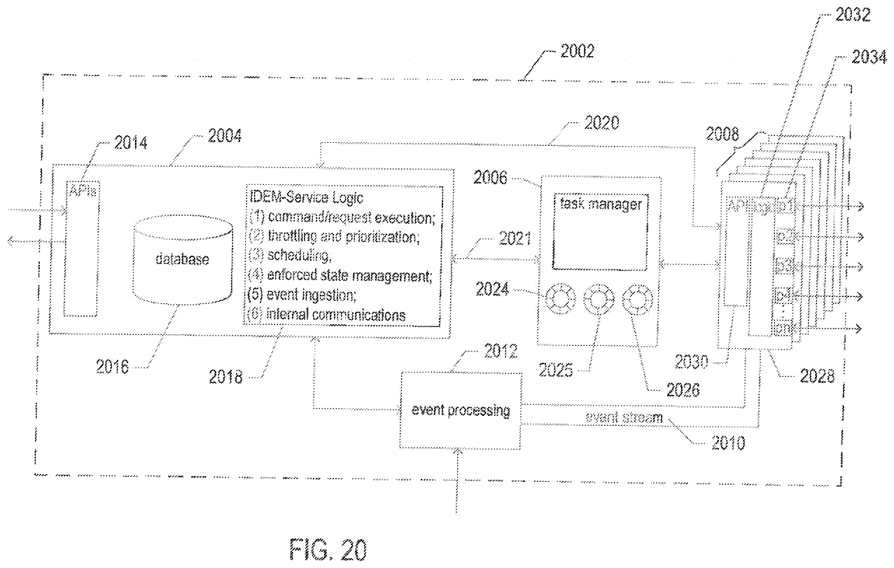

FIG. 20 illustrates one implementation of the Idem service. The Idem service 2002 includes an Idem-service frontend 2004, a task manager 2006, multiple Idem-service workers 2008, with the number of Idem-service workers scalable to handle dynamic workloads, an event stream 2010, and an event-processing component 2012. The Idem-service frontend 2004 includes the previously discussed set of GraphQL APIs 2014 and a database 2016 for storing information related to managed infrastructure and received Idem requests and commands. The frontend additionally includes Idem-service logic 2018 that implements command/request execution, throttling and prioritization, scheduling, enforced-state management, event ingestion, and internal communications between the various components of the Idem service. Throttling involves managing the workload accepted by the Idem service to ensure that sufficient computational resources are available to execute received commands and requests. Prioritization involves prioritizing execution of received Idem commands and requests. Scheduling involves preemption of long-running Idem-command-and-request executions. Enforced state management involves maintaining a representation of the last enforced state of a particular infrastructure managed by the Idem service in order to facilitate subsequent command/request execution. Event ingestion involves receiving, storing, and acting on events input to the Idem-service frontend by the event-processing component 2012. The various components of the Idem service communicate by message passing, as indicated by double-headed arrows 2020-2022. The task manager 2006 coordinates various stages of execution of Idem commands and requests using numerous task queues 2024-2026. Each Idem-service worker, such as Idem-service worker 2028, presents an Idem-service worker API 2030 and includes logic 2032 that implements Idem-command-and-request execution. Each Idem-service worker includes a set of one or more plug-ins, such as plug-in 2034, allowing the Idem-service worker to access the management interfaces of cloud-computing facilities on which infrastructure managed by the Idem service is deployed and configured. As they execute commands and requests, Idem-service workers publish events to the event stream 2010. These events are monitored and processed by the event-processing component 2012, which filters the events and forwards processed events to the Idem-service frontend.

### Currently Disclosed Methods and Systems

Although, as discussed above, the Idem service provides many advantages to those who manage and administer cloud infrastructure, it may be difficult for managers and administrators who are currently managing deployed cloud infrastructure to learn to read and write SLS specification-and-configuration documents. Although the above-described SLS-data blueprints or cloud templates allow cloud-infrastructure deployments and configurations to be easily and intuitively created for deployment and configuration of cloud infrastructure via the Idem-service state command, there is still a learning curve associated with adopting the SLS-data-cloud-template approach. This learning curve involves learning how to encode cloud-infrastructure deployment and configuration in a set of SLS data files that together comprise a parameterized cloud template, but also involves the potentially difficult task of determining the resources and associated resource attributes for cloud infrastructure already deployed in cloud-computing facilities. As one example, an administrator or manager may wish to add a new instance of a particular type of resource to an SLS-data cloud template for instantiation in a cloud-computing facility and may wish to use the specification-and-configuration information contained in an existing SLS-data cloud template as a model or template for specifying and configuring the new instance of the particular type of resource. However, finding the specification-and-configuration information for an instance of the particular type of resource in an existing SLS-data cloud template may involve reading through, or searching through, tens, hundreds, or more pages of SLS specification-and-configuration documents. Furthermore, the administrator or manager may wish to examine numerous examples of the existing specification-and-configuration information for multiple instances of the particular type of resource in order to understand the available options for specifying and configuring a new instance of a particular type of resource, which further compounds the task of reading through, or searching through, tens, hundreds, or more pages of SLS specification-and-configuration documents for the specification-and-configuration information for multiple instances of the particular type of resource. It would be highly valuable to administrators and managers to be able to organize specification-and-configuration information into groups of different types of resources, where the different types of resources are associated with different values of one or more keys or categories, but manually organizing specification-and-configuration information would be a daunting and infeasible task, for common infrastructure configurations and specifications.

To resolve the problems discussed in the preceding paragraph, an automated specification-and-configuration-information segregator has been recently developed and incorporated into the Idem service. In one mode of operation, the automatic segregator receives one or more raw specification-and-configuration files and partitions the resources specified in the one or more raw specification-and-configuration files into category-associated resource groups. The specifications and configuration information for the grouped resources that are then stored in category-associated files that may, in turn, be stored in category-associated subdirectories of a file-system directory.

FIG. 21 illustrates a first mode of operation of the currently disclosed automated segregator. The automated segregator 2102 receives one or more raw SLS data files 2104 and partitions the resource specifications contained in the received raw SLS data files into category-associated groups of resource specifications. The category-associated groups of resource specifications are then written to category-associated SLS data files 2106-2109 which may, in turn, be contained within category-associated subdirectories 2110-2113 within a file-system directory 2116. There may be multiple levels of category-associated subdirectories, as further discussed below.

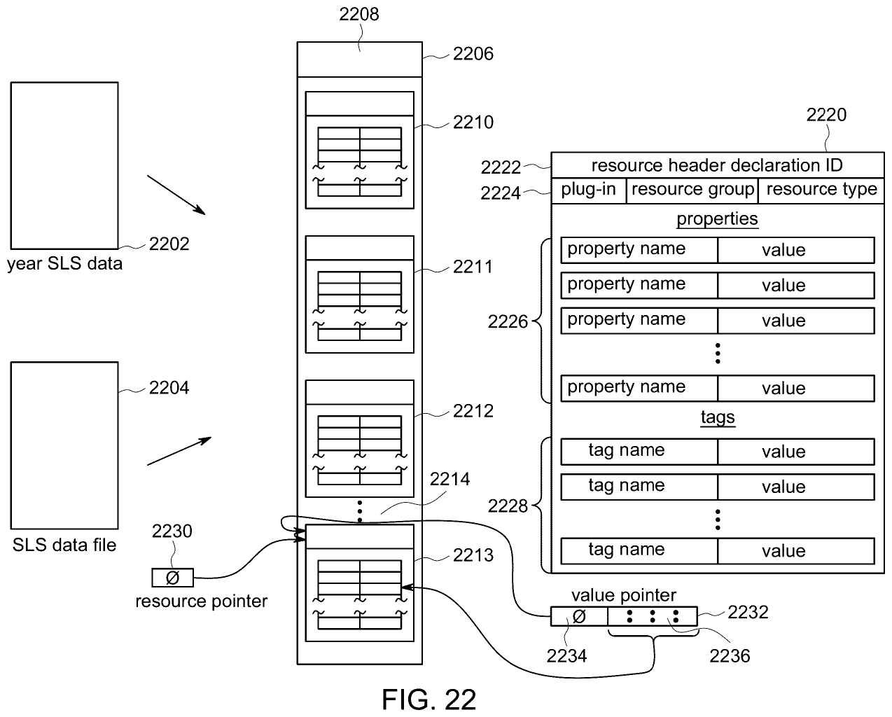

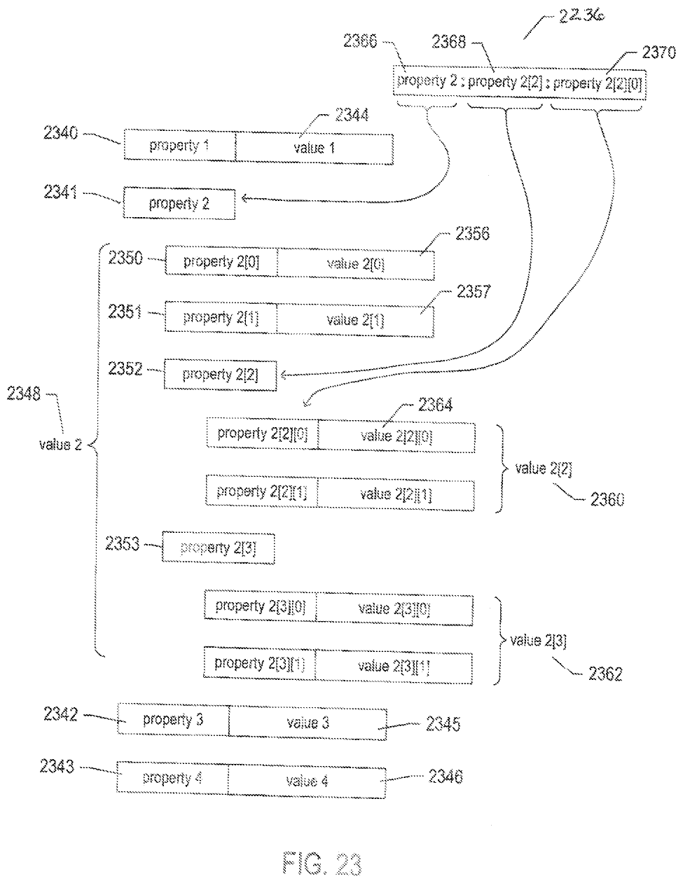

FIG. 22 illustrates an initial step carried out by the automated segregator during partitioning of resource specifications into category-associated groups of resource specifications. The Idem service receives one or more raw SLS data files 2202 or one or more processed SLS data files 2204, allocates an in-memory data structure 2206, and loads the information contained in the one or more raw or processed SLS data files into the in-memory data structure 2206. The in-memory data structure includes general information extracted from the one or more SLS data files 2208 along with a set of resource descriptors 2210-2213, alternatively referred to as “resource data structures,” with ellipsis 2214 indicating that the set of resource descriptors shown in FIG. 22 may include many additional resource descriptors. The in-memory data structure thus contains the same information that is contained in the input SLS data files, but in a highly formatted data structure that allows for efficient computational processing. In addition, the in-memory data structure closely parallels the content and formatting of an SLS data file.

FIG. 22 also shows a resource descriptor 2220 representative of the resource descriptors within the in-memory data structure. The resource descriptor or resource specification includes a resource header declaration ID 2222 (1808 in FIG. 18A), referred to as a “state name” in the example SLS state file discussed in FIG. 18A and referred to, below, simply as a “resource ID,” a plug-in/resource-group/resource-type tuple 2224 (for example, the plug-in/resource-group/resource-type tuple in directive 1810 in FIG. 18A), a list of property-name/property-value pairs 2226 (1812 in FIG. 18A), and a list of tag-name/tag-value pairs 2228 (1814 in FIG. 18A). In the following discussion, properties and tags are generally referred to as “attributes” and property and tag values are referred to as “attribute values,” since the distinction between properties and tags is not particularly relevant to the currently disclosed methods and systems. A resource reference or pointer 2230 references a particular resource descriptor 2213 within the in-memory data structure 2208. In certain implementations, a resource pointer is a memory address of the initial word or byte in a resource descriptor while, in other implementations, a resource pointer may be an integer index into an array implementation of the resource descriptors in the in-memory data structure. It is convenient to computationally generate a pointer, or reference, 2232 to a particular attribute value in the in-memory data structure and in SLS data files. Such references may be used in argument bindings, for example, to refer to an attribute value. An attribute-value reference, or pointer, includes a resource pointer 2234 and a generally multi-part reference 2236 to a particular attribute value within the resource descriptor referenced by the resource pointer 2234.

FIG. 23 illustrates the contents of the multi-part-reference portion of an attribute-value pointer. The attributes within a resource specification or descriptor may be hierarchically structured. FIG. 23 shows an example hierarchical structure of attributes. There are four highest-level attributes 2340-2343. Three of the highest-level attributes, attribute 1 (2340), attribute 3 (2342), and attribute 4 (2343), have simple values 2344-2346. However, attribute 2 (2341) has a complex value 2348 that includes four second-level attributes 2350-2353. Second-level attributes 2350 and 2351 both have simple values 2356-2357. However, second-level attributes 2352 and 2353 both have complex values consisting of a pair of third-level attributes 2360 and 2362. In the example shown in FIG. 23, the multi-part-reference portion of an attribute-value pointer (2236 in FIG. 22) comprises a list of colon-separated subfields containing references to a first-level, second-level, and third-level attribute, with the third-level attribute referenced by the attribute-value pointer containing the multi-part-reference portion. A first subfield 2366 of the multi-part-reference portion of the attribute-value pointer references the first-level attribute 2341 in which value 2364 is contained. A second subfield 2368 of the multi-part-reference portion of the attribute-value pointer includes a reference to a second-level attribute 2352 in which value 2364 is contained. A third subfield 2370 of the multi-part-reference portion of the attribute-value pointer contains a reference to the third-level attribute 2364. Of course, the multi-part-reference portion of an attribute pointer contains only a sufficient number of colon-separated subfields to identify a particular attribute value, and may include a single subfield when the referenced value is that of a first-level attribute.

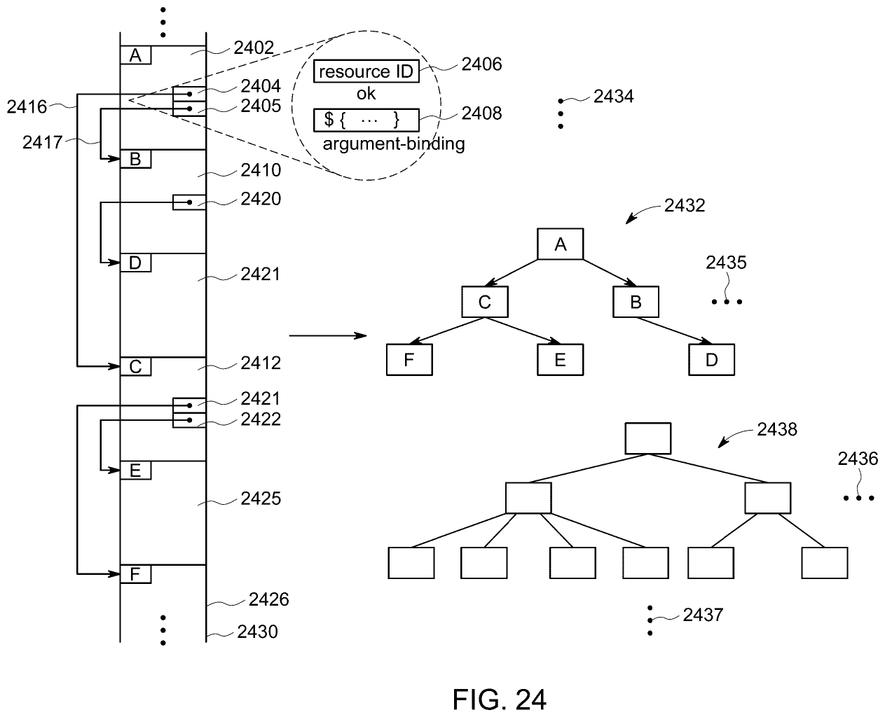

FIG. 24 illustrates the hierarchical organization of resource descriptors within the in-memory data structure discussed above. A resource descriptor, such as resource descriptor 2402, may include one or more attribute values 2404-2405 that each contains either a resource ID 2406, in the case of raw SLS data, or an argument-binding expression 2408, in the case of processed SLS data, that act as references to other resource descriptors 2410 and 2412, as indicated by curved arrows 2414 and 2416. The referenced resource descriptors 2410 and 2412 may, in turn, contain attribute values 2420-2422 that act as references to still additional resource descriptors 2424-2426. The resource descriptors and resource-descriptor references shown in a small portion 2430 of the in-memory data structure may thus represent a hierarchical organization 2432 of the resource descriptors that is represented as an acyclic graph. As indicated by ellipses 2434-2437 and acyclic graph 2438, the resource descriptors within the in-memory data structure may be organized into a forest of acyclic graphs using the attribute values within resource descriptors that reference other resource descriptors.

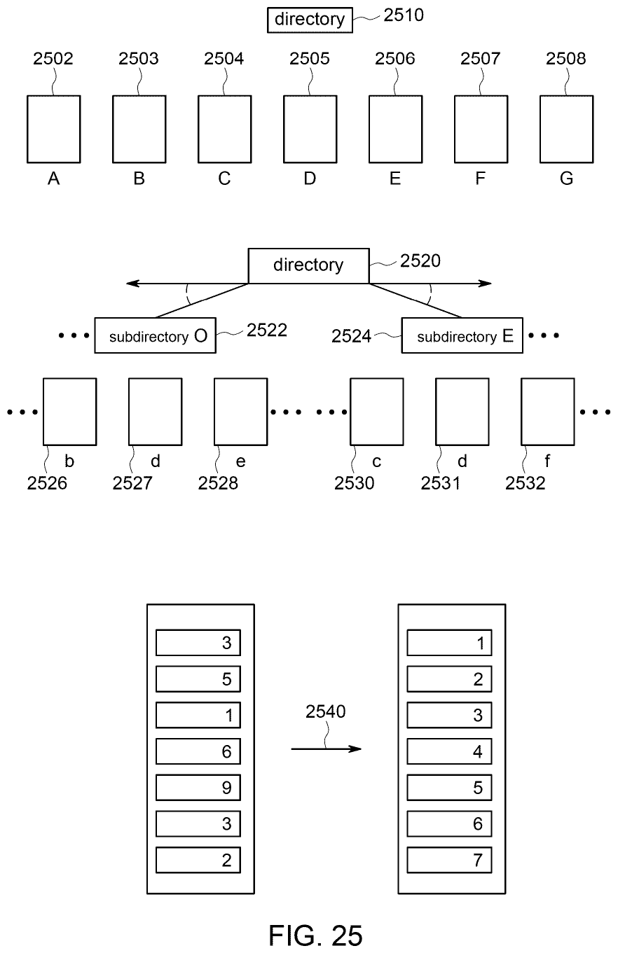

FIG. 25 illustrates three different types of category associations carried out by the currently disclosed segregated to group resource specifications and configurations. A first type of category association involves assigning a particular category value to each of multiple files 2502-2508 within a file-system directory 2510. In this example, each file is associated with a different category value represented by a capital letter. The associations of category values to files may be implemented by including a textual representation of the category values in the file names. For example, the grouping category in this example may be the category resource type and the category values, represented by the capital letters, comprise the different types of resources in the input SLS data files. An actual representation would generally use human-understandable character strings rather than capital letters to represent category values. A second type of category association involves assigning category values to subdirectories within a file-system directory in addition to assigning category values to files within the subdirectories. In the illustrated example in FIG. 25, the file-system directory 2520 contains multiple different subdirectories, including subdirectories 2522 and 2524. Each subdirectory is associated with a category value of a first category. The files within each of the subdirectories, including files 2526-2528 within subdirectory 2522 and files 2530-2532 within subdirectory 2524, are associated with values of a second category. For example, the first category may be resource type and the second category may be cloud provider or cloud service. A third type of category association may involve ordering of the sequence of resource descriptors within a given file with respect to the values of a category, where the category-value-based ordering is represented by arrow 2540. In an implementation described below, category associations are represented by incorporating category values into the names of file directories and files as well as by ordering file descriptors within files with respect to category values. Other approaches for associating files and subdirectories with category values are possible.

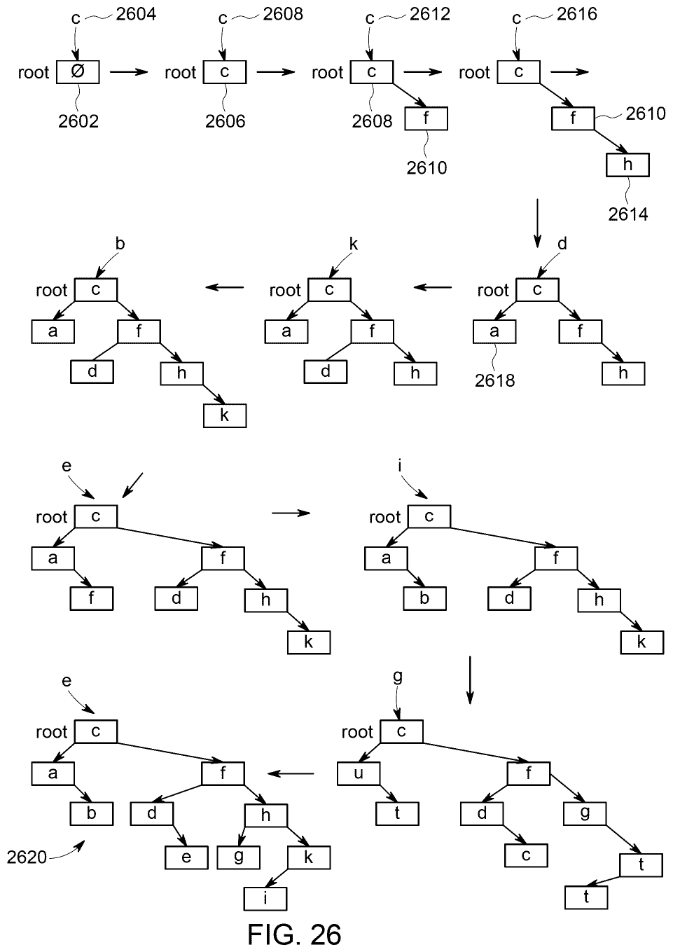

FIG. 26 illustrates construction of a binary search tree. In one implementation of the currently disclosed automated segregator, discussed below, binary search trees are used to index resource descriptors in order to generate category-associated resource-descriptor groupings represented by file-system-subdirectory names, file names, and the ordering of resource descriptors within files, as discussed above with reference to FIG. 25. A binary search tree is constructed for items associated with identifiers by storing the unique identifiers in nodes of an acyclic binary tree. The acyclic binary tree can then be recursively traversed to generate an ordered list of the unique identifiers. Construction of a binary search tree assumes that the entity identifiers are orderable via a comparison operation. The example shown in FIG. 26, the process begins with an empty binary search tree 2602. The first received identifier c 2604 is placed into the root node 2606 to generate a binary search tree with the single node. A next identifier f 2608 is received. Because f is greater than c, assuming that the identifiers are alphabetically ordered, the identifier f is placed into a right child node 2610 of the root node 2606. A third identifier h 2612 is placed into a right child node 2614 of the node containing identifier f 2610 since identifier h is greater than both previously stored identifiers c and f. As each new identifier is received, the binary search tree is traversed, starting with a root node, to identify a position for the new identifier in the binary search tree. For example, when the identifier a 2016 is received, the identifier a is first compared with the identifier stored in the root node c. Since a is less than c, the traversal proceeds to the left child of the root node. Since there is no left child in the root node, a new node 2618 is constructed for identifier a. In the example of FIG. 26, 10 identifiers are received and stored in the binary search tree to produce the final binary search tree 2620.

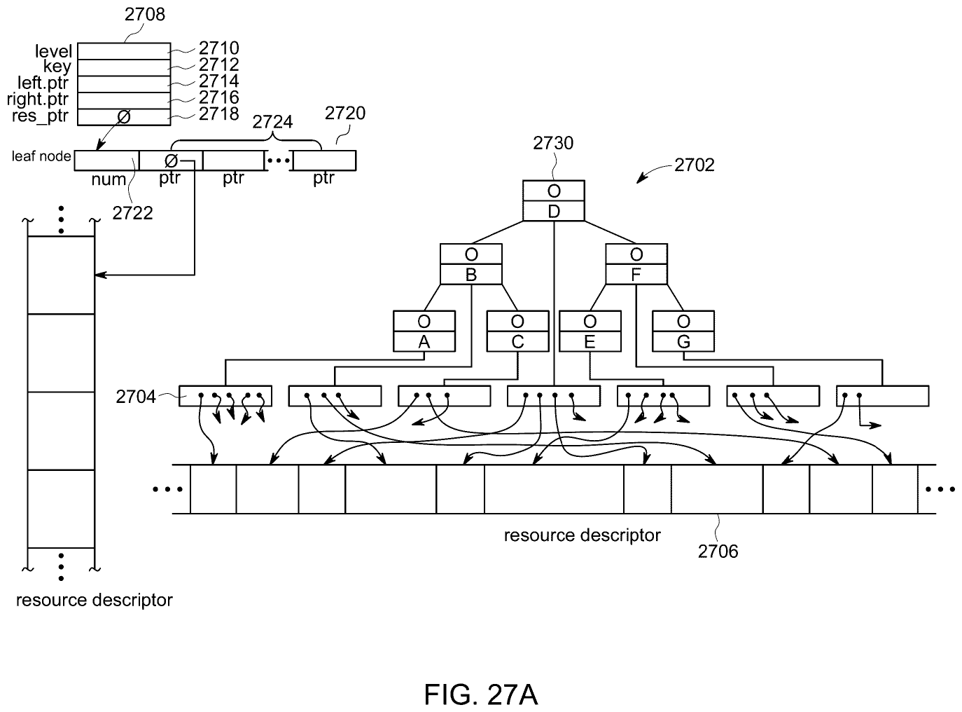

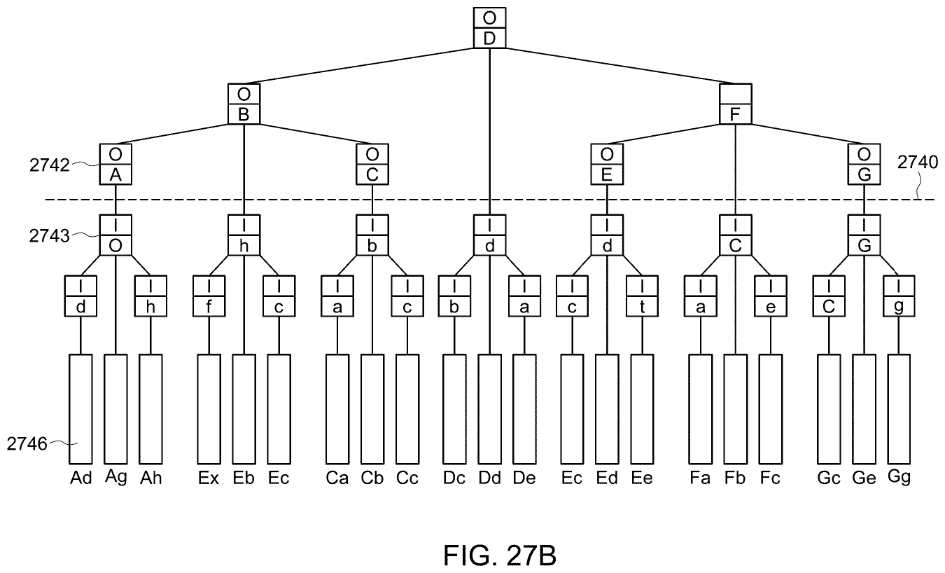

FIGS. 27A-B illustrate a data structure used in one implementation of the currently disclosed segregator to group resource descriptors. The data structure includes an acyclic graph 2702 with leaf nodes, such as leaf node 2704, containing resource pointers or references that reference resource descriptors in the in-memory data structure 2706. The non-leaf nodes of the acyclic graph, shown in the upper left portion of FIG. 27A 2708, each includes: (1) a level field 2710 that includes an integer value indicating the category level to which the node belongs; (2) a key field 2712 that contains a unique category value; (3) a left_ptr field that contains a reference to a left-hand child node 2714; (4) a right_ptr field 2716 contains a pointer or reference to a right-hand child node; and (5) a res_ptr field 2718 that contains a pointer to a leaf node. Each leaf node 2720 includes a num field 2722 that indicates the number of resource pointers contained in the leaf node and a list of resource pointers 2724. The non-leaf nodes represent a binary search tree. Each leaf node contains resource pointers to resource descriptors in the in-memory data structure associated with the category value contained in the key field of the non-leaf node that references the leaf node. In FIG. 27A, only the level and key fields are shown for the non-leaf nodes, such as non-leaf node 2730, in the data structure. The data structure shown in FIG. 27A produces the category-associated files 2502-2508 in a file-system directory as shown in the first example of FIG. 25.

FIG. 27B shows a multi-level example of the data structure discussed above with reference to FIG. 27A. The non-leaf nodes above the horizontal dashed line 2740 are similar to the non-leaf nodes in the data structure shown in FIG. 27A. However, the non-leaf nodes below the dashed horizontal line 2740, such as non-leaf nodes 2742-2744, represent a second level of non-leaf nodes containing key values for a second category. The data structure shown in FIG. 27B produces the category-associated subdirectories and files 2522, 2424, 2526-2528, and 2530-2532 shown in the second example of FIG. 25. The non-leaf nodes above the horizontal dashed line 2740 represent the key values for the subdirectories and the non-leaf nodes below the horizontal dashed line 2740 represent the key values for the individual files within the subdirectories. Leaf node 2746, for example, contains references to resource descriptors associated with first-category value A and second-category value d. An arbitrary number of categories/levels can be represented by data structures such as those shown in FIGS. 27A-B, with additional levels of non-leaf nodes added for each additional category.

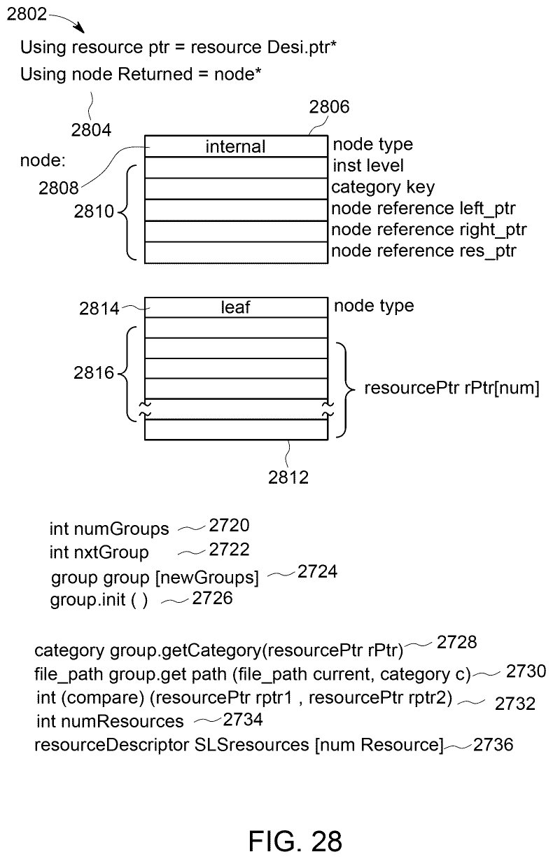

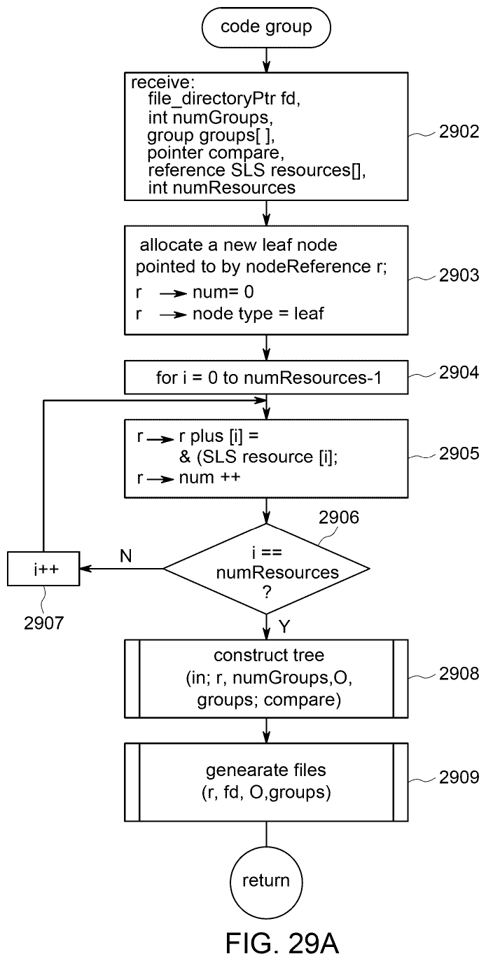

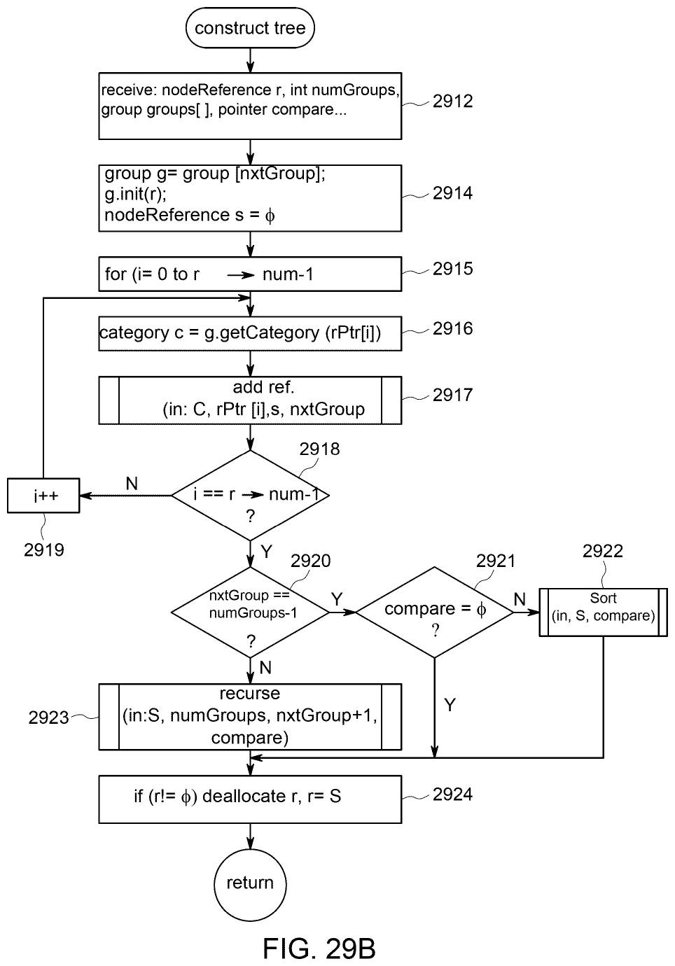

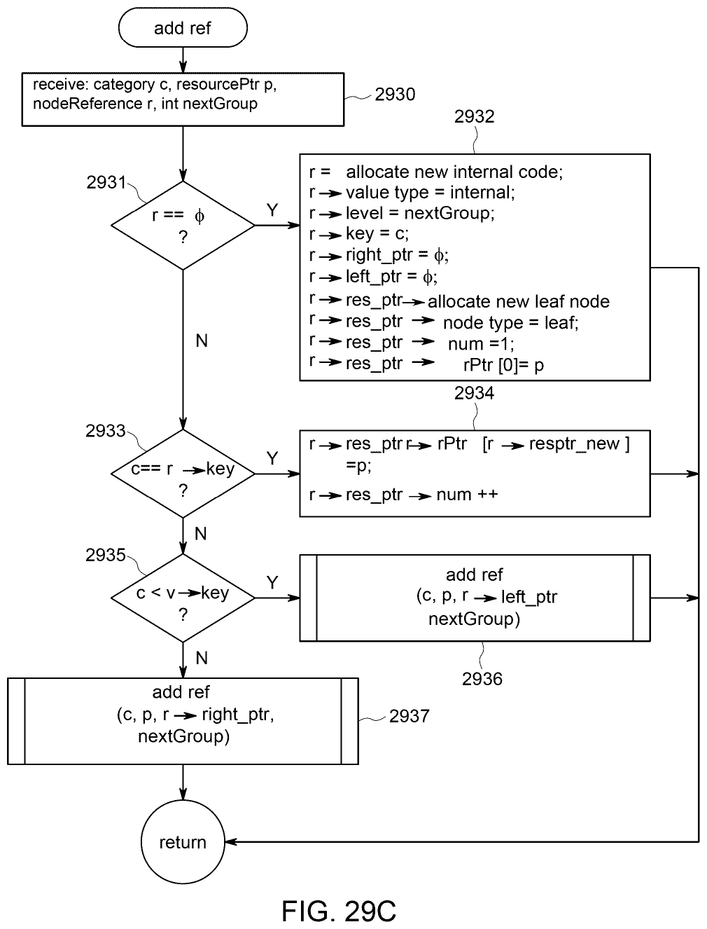

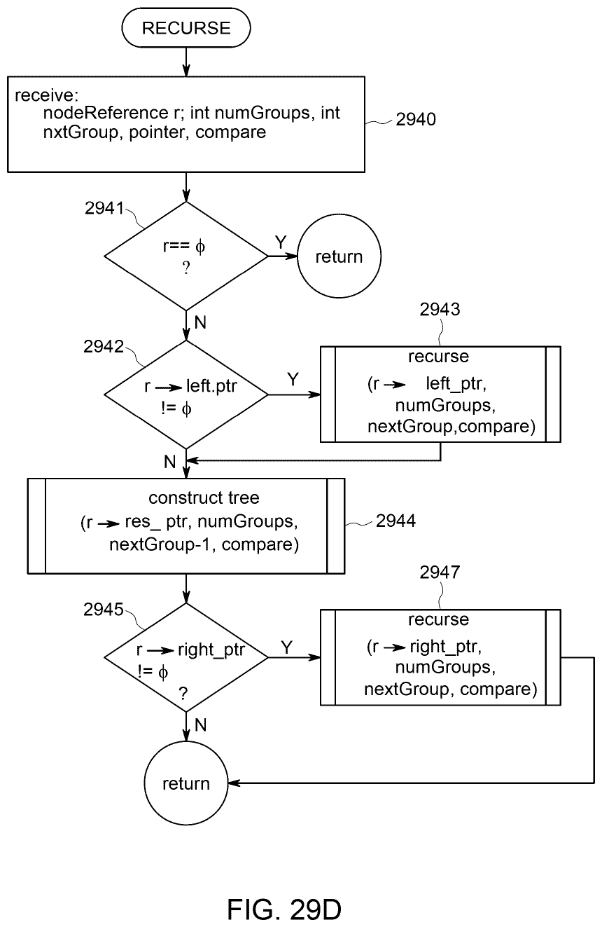

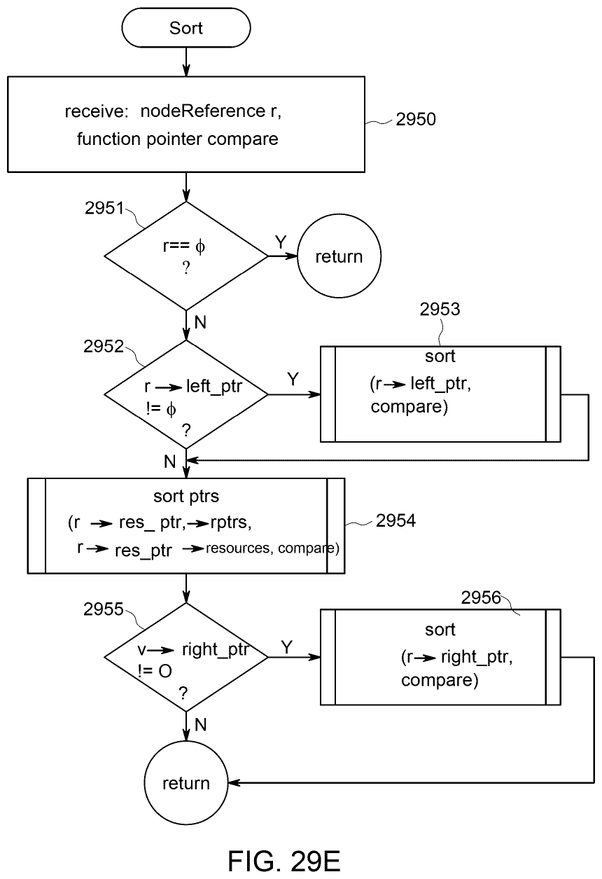

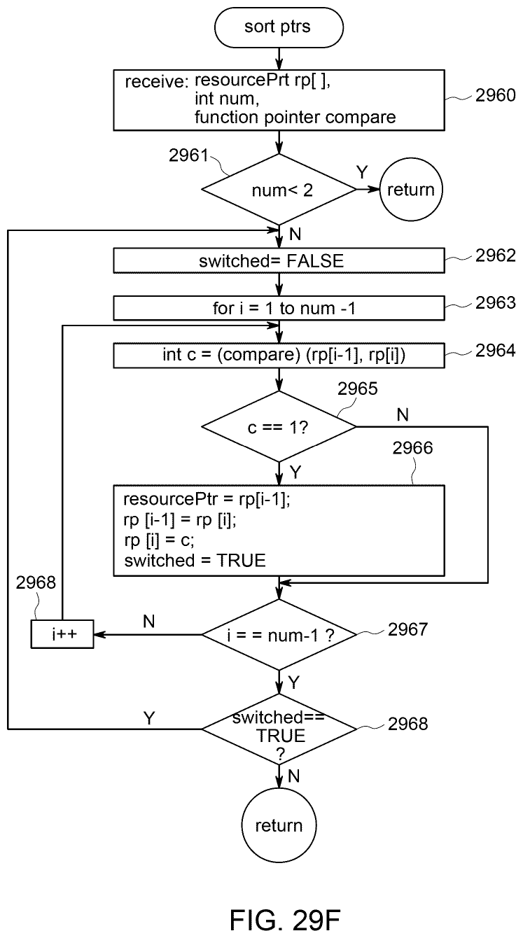

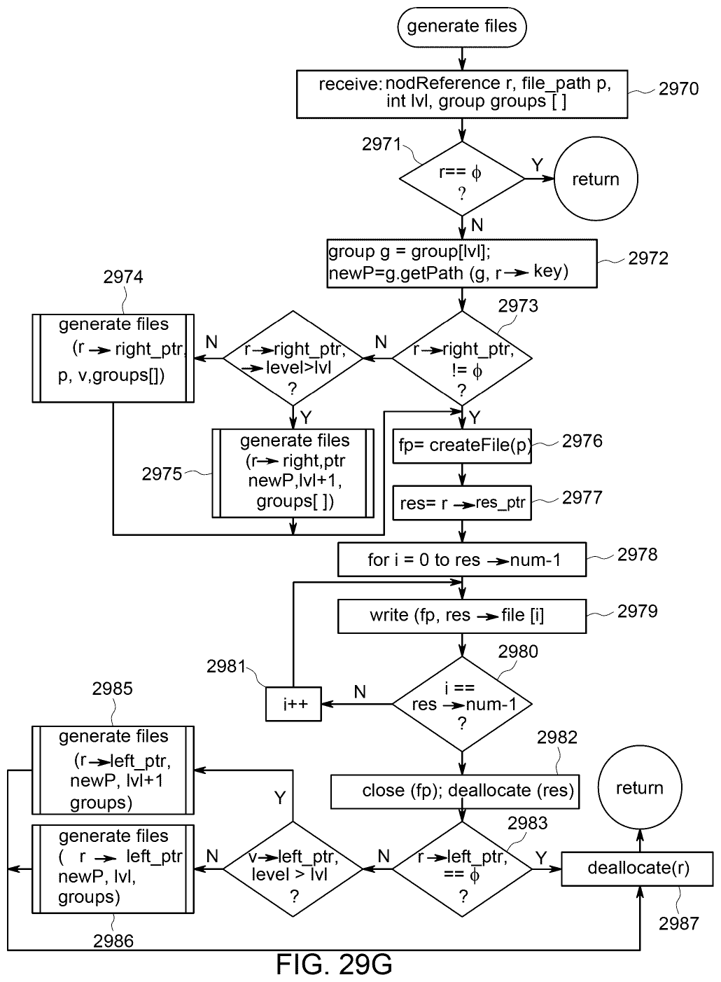

FIG. 28 illustrates several different datatypes, data structures, and classes used in a flow-control-diagram description of an implementation of the currently disclosed segregator that follows, in FIGS. 29A-G. The datatypes resourcePtr 2802 and nodeReference 2804 are pointers to resource descriptors and to acyclic-graph nodes, respectively. The non-leaf nodes 2806 of the acyclic-graph data structure include a first field containing an indication of the node type internal 2808 and the five additional fields 2810 discussed above with reference to fields 2708, 2710, 2712, 2714, 2716, and 2718 in FIG. 27A. The leaf nodes of the acyclic-graph data structure 2012 include a first field containing an indication of the node type leaf 2814 and the additional fields 2816 discussed above with reference to fields 2722 and 2724 in FIG. 27A. The integer numGroups 2720 contains the number of groups or categories used to group and order the resource descriptors. The integer nxtGroup 2722 contains an indication of the currently considered category or group. The array groups 2724 contains an instance of the class group for each category. An instance of the class group represents a category. The class group includes an initialization function 2726, a member function getCategory 2728 which receives a resource pointer as an argument and returns a category value for the resource descriptor referenced by the resource pointer, and a member function getPath 2730 that receives a current file path and a category value as arguments and returns a lower-level file path that incorporates the category value. A function compare 2732 returns an integer value indicating whether or not a resource descriptor referenced by a first resource-pointer argument is less than, equal to, or greater than a resource descriptor referenced by a second resource-pointer argument. The integer numResources represents the number of resource descriptors in the in-memory data structure 2734 and the array SLSresources 2736 represents the in-memory data structure.

FIGS. 29A-G provides control-flow diagrams that illustrate one implementation of the currently disclosed automated segregator. FIG. 29A provides a control-flow diagram for a routine “code group” which carries out the resource-descriptor partitioning discussed above with reference to FIG. 21. In step 2902, the routine “code group” receives a file directory pointer fd, the number of groups or categories numGroups to use in grouping resource descriptors, an array of group instances groups, a pointer to a compare function, and a reference to the in-memory data structure and an indication numResources of the number of resource descriptors in the in-memory data structure. In step 2903, the routine “code group” allocates a new leaf node pointed to by the nodeReference r, sets the num field of the new leaf node to 0, and sets the node type to leaf. In the for-loop of steps 2904-2907, pointers to the resource descriptors in the in-memory data model are added to the new leaf node. Note that leaf nodes, in the currently disclosed implementation, have variable sizes that are automatically expanded as reference pointers are added to the leaf nodes. In step 2908, a routine “construct tree” is called to construct a data structure, such as those described with reference to FIGS. 27A-B, to partition the resource descriptors by category values. In step 2909, a routine “generate files” is called to store the partitioned resource descriptors into files within a directory or within a hierarchical file-system structure that includes one or more levels of subdirectories, as discussed above.

FIG. 29B provides a control-flow diagram for the routine “construct tree,” called in step 2908 of FIG. 29A. In step 2912, the routine “construct tree” receives a nodeReference r, passed by reference, and other of the arguments previously received by the routine “code group,” discussed above with reference to step 2902 in FIG. 29A. The nodeReference r references a leaf node of a data structure such as those discussed with reference to FIGS. 27A-B. In step 2914, the routine “construct tree” sets local variable g to the currently considered group in the array groups, calls the initialization routine for the currently considered group g, and sets a local nodeReference variable s to NULL. In the for-loop of steps 2915-2919, the routine “construct tree” calls the member function getCategory for the currently considered group g to obtain category values for each resource descriptor referenced from the leaf node referenced by nodeReference r and then calls a routine “add ref” to add the currently considered resource descriptors and associated category values to a new data structure referenced by local nodeReference s. Following completion of the for-loop of steps 2915-2919, the routine “construct tree” determines, in step 2920, whether the currently considered group is the last group in the array groups. If so, and when a pointer to a compare routine has been received by the routine “construct tree,” as determined in step 2921, a routine “sort” is called, in step 2922, to sort the resource descriptors in the data structure referenced by local nodeReference variable s. When the currently considered group is the last group in the array groups, as determined in step 2920, a routine “recurse” is called, in step 2923, to generate a next level in the acyclic data structure corresponding to a next group in the array groups. Finally, in step 2924, the leaf node referenced by nodeReference r is deallocated and r is set to the value of local nodeReference s. Thus, the routine “construct tree” constructs an acyclic data structure from the resource pointers in a received leaf node and replaces the leaf node with the acyclic data structure. The routine “recurse” recursively calls the routine “construct tree” to generate additional levels of the final acyclic data structure returned by the call to the routine “construct tree” in step 2908 of FIG. 29A.

FIG. 29C provides a control-flow diagram for the routine “add ref,” called in step 2917 of FIG. 29B. In step 2930, the routine “add ref” receives a category value c, a resourcePtr p, a nodeReference r, passed by reference, and the index of a currently considered group nextGroup. When r is NULL, as determined in step 2931, the routine “add ref,” in step 2932, allocates a new internal node and initializes the internal node, including allocating a new leaf node referenced by the new internal node. Note that the new internal node contains the category value c in the field key. Otherwise, when category value c is equal to the category value stored in the key field of the internal node referenced by nodeReference r, as determined in step 2933, the received resourcePtr p is added to the leaf node referenced by the internal node referenced by nodeReference r, in step 2934. Otherwise, when category value c is less than the category value stored in the key field of the internal node referenced by nodeReference r, as determined in step 2935, the routine “add ref” is recursively called, in step 2936, as a next step in a recursive traversal of the acyclic graph to the left child of the internal node referenced by nodeReference r, and, otherwise, the routine “add ref” is recursively called, in step 2937, as a next step in a recursive traversal of the acyclic graph to the left child of the internal node referenced by nodeReference r. Thus, the routine “add ref” traverses an acyclic graph in order to add a node reference to an existing internal node or to create a new internal node and add the node reference to the newly created internal node.

FIG. 29D provides a control-flow diagram for the routine “recurse,” called in step 2923 of FIG. 29B. In step 2940, the routine “recurse” receives many of the arguments received by the routine “construct tree” in step 2912 of FIG. 29B, with the exception that the routine “construct tree” increments the argument nxtGroup when calling the routine “recurse” in step 2923. When nodeReference r is NULL, as determined in step 2941, the routine “recurse” returns. Otherwise, when the left child pointer in the node referenced by nodeReference r is not NULL, as determined in step 2942, the routine “recurse” recursively calls itself, in step 2943, for the left child of the node referenced by nodeReference r. In step 2944, the routine “construct tree” is called to construct an acyclic data structure for the leaf node referenced by the internal node referenced by nodeReference r. Finally, when the right child pointer in the node referenced by nodeReference r is not NULL, as determined in step 2945, the routine “recurse” recursively calls itself in step 2949 for the right child of the node referenced by nodeReference r.

FIG. 29E provides a control-flow diagram for the routine “sort,” called in step 2922 of FIG. 29B. The routine “sort” receives a nodeReference r by reference and a pointer to a function compare in step 2950. When nodeReference r is NULL, as determined in step 2951, the routine “sort” returns. Otherwise, when the left child pointer in the node referenced by nodeReference r is not NULL, as determined in step 2952, the routine “sort” recursively calls itself in step 2953 for the left child of the node referenced by nodeReference r. In step 2954, the routine “sort” calls a routine “sort ptrs” to sort the resource pointers in the leaf node referenced by the internal node referenced by nodeReference r. Finally, when the right child pointer in the node referenced by nodeReference r is not NULL, as determined in step 2955, the routine “sort” recursively calls itself in step 2956 for the right child of the node referenced by nodeReference r.

FIG. 29F provides a control-flow diagram for the routine “sort ptrs,” called in step 2954 of FIG. 29E. This routine implements a simple bubble sort using the compare function for which a function pointer is received as an argument. The routine “sort ptrs” receives a reference rp to the resource pointers in a leaf node, an indication num of the number of resource pointers in the leaf node, and a pointer to a function compare, in step 2960. When num is less than 2, as determined in step 2961, the routine “sort ptrs” returns since no sorting is needed. Otherwise, in step 2962, the routine “sort ptrs” sets local variable switched to FALSE. In the for-loop of steps 2963-2968, each successive pair of resource pointers is compared and the resource pointers are interchanged when the resource descriptor referenced by the first resource pointer of the pair is greater than the resource descriptor referenced by the second resource pointer of the pair, as determined by the function compare. Whenever a pair of resource pointers is interchanged, the local variable switched is set to TRUE, in step 2966. Following completion of the for-loop of steps 2963-2968, when the local variable switched has the value TRUE, as determined in step 2968, control returns to step 2962 for another iteration of the for-loop of steps 2963-2968. Although bubble sorts are inefficient for large numbers of entities, the routine “sort ptrs” is only called for leaf nodes following category-value-partitioning of the resource descriptors in the in-memory data structure, and thus is called for relatively small numbers of entities, in general. Other sorting methods, such as quicksort, may be alternatively used.

FIG. 29G provides a control-flow diagram for the routine “generate files,” called in step 2909 of FIG. 29A. The routine “generate files” receives, by reference, a nodeReference r, receives a file path p, receives an indication of a current level lvl, and receives an array of groups groups, in step 2970. When nodeReference r is NULL, as determined in step 2971, the routine “generate files” returns. In step 2972, a local variable g is set to the currently considered group and a local file path newP is constructed via a call to the group member function getPath. When the right child pointer in the node referenced by nodeReference r is not NULL, as determined in step 2973, the routine “generate files” recursively calls itself, in step 2974, for the right child of the node referenced by nodeReference r when the right child is at the same level as the internal node referenced by nodeReference r and otherwise recursively calls itself, in step 2975, for the right child of the node referenced by nodeReference r when the right child is at a greater level than the level of the internal node referenced by nodeReference r. In step 2976, the routine “generate files” creates a new file and, in step 2977, sets local variable res to reference the leaf node referenced from the internal node referenced by nodeReference r. Note that the file-creation routine creates any subdirectories in the file path that have not yet been created in addition to creating a new file corresponding to the file pathp. Then, in the for-loop of steps 2978-2981, the routine “generate files” writes the resource descriptors referenced by the resource pointers in the leaf node to the new file. In step 2982, the routine “generate files” closes the newly created file and deallocates the leaf node referenced from the internal node referenced by nodeReference r. When the left child pointer in the node referenced by nodeReference r is not NULL, as determined in step 2983, the routine “generate files” recursively calls itself, in step 2985, for the left child of the node referenced by nodeReference r when the left child is at the same level as the internal node referenced by nodeReference r and otherwise recursively calls itself in step 2986 for the left child of the node referenced by nodeReference r when the left child is at a greater level than the level of the internal node referenced by nodeReference r.

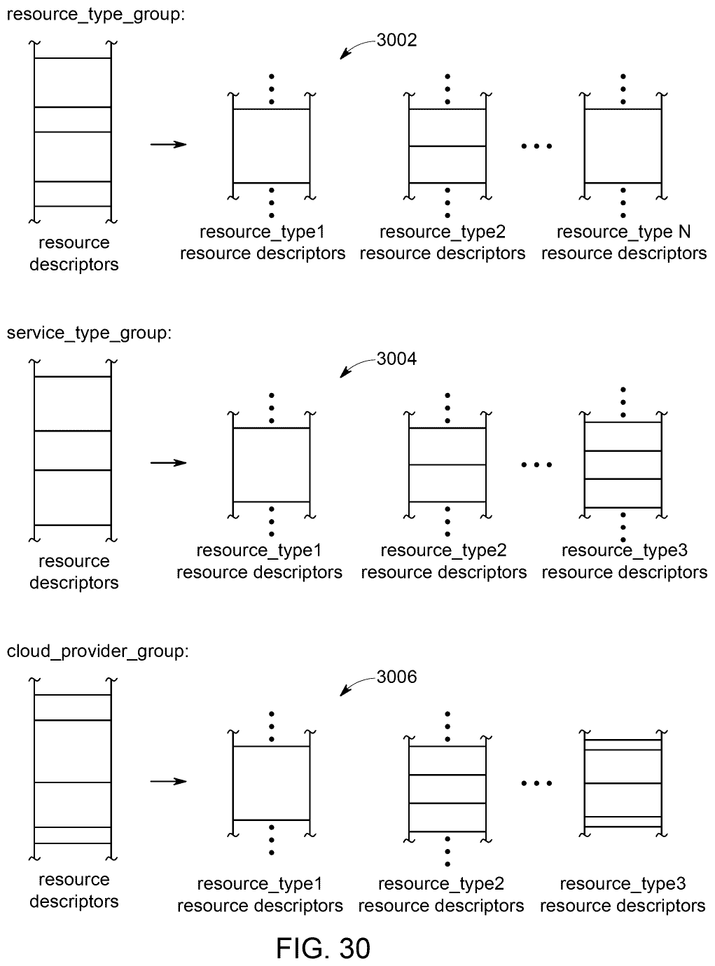

FIG. 30 illustrates three specific types of resource-descriptor groupings that can be carried out by the currently disclosed automated segregator. Resource descriptors may be grouped by resource type, shown in the first example 3002 in FIG. 30. Alternatively, as shown in the second example 3004 in FIG. 30, resource descriptors may be grouped by service type. Finally, as shown in the third example 3006 in FIG. 30, resource descriptors may be grouped by cloud provider. As discussed above with reference to FIG. 22, the plug-in/resource-group/resource-type tuple 2224 in a resource descriptor 2220 contains indications of a cloud provider or plug-in module specific to a particular cloud provider, a service type or resource group, and a resource type. Thus, values in the plug-in/resource-group/resource-type tuple 2224 can be used for assigning category values to resource descriptors in order to group the resource descriptors by category values, as shown in FIG. 30.

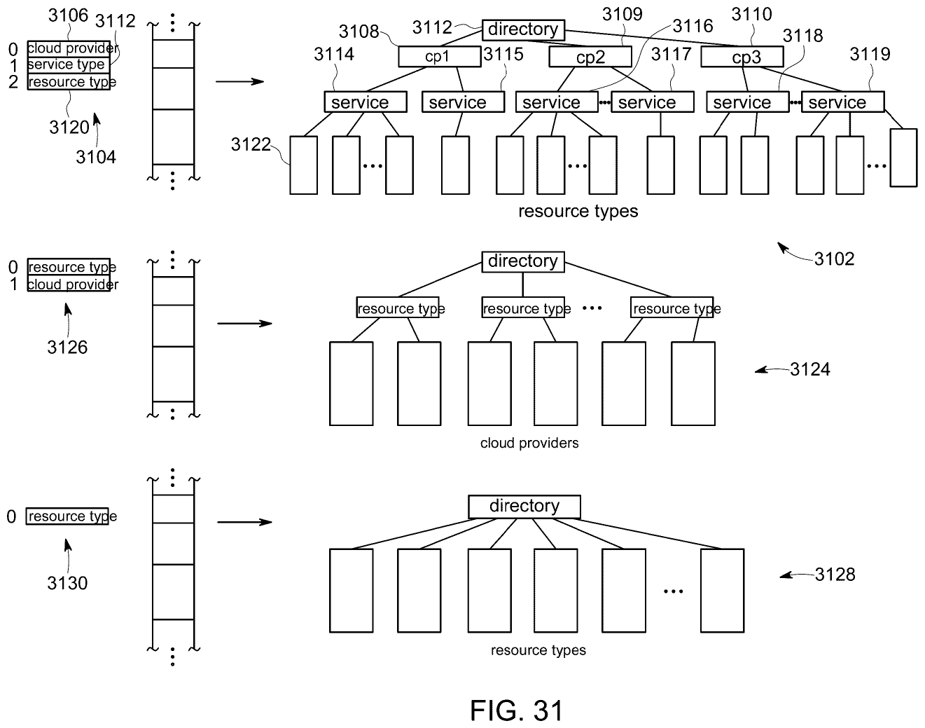

FIG. 31 illustrates grouping resource descriptors by multiple different category values corresponding to multiple different categories. A first example 3102 of the above-described resource-descriptor grouping provides a grouping of resource descriptors within a file-system hierarchy that is based on three different categories 3104. Each different cloud provider represents a category value for the cloud-provider category 3106, and the cloud-provider names or identifiers are therefore incorporated into the first-level subdirectory names 3108-3110 in the file-system hierarchy below a specified directory 2112. Each different service type represents a category value for the service-type category 3112, and the service names are therefore incorporated into the second-level subdirectory names 3114-3119. Each different resource type represents a category value for the resource-type category 3120, and the resource-type names or identifiers are therefore incorporated into the file names of the files which contain groups of resource descriptors, such as file 3122. A fourth category may be used to order the sequence of file descriptors within each file. Example 3124 shows a single-level file-system hierarchy specified by two different categories 3126 and example 3128 shows resource descriptors partitioned among files of the specified directory according to values of a single category 3130.

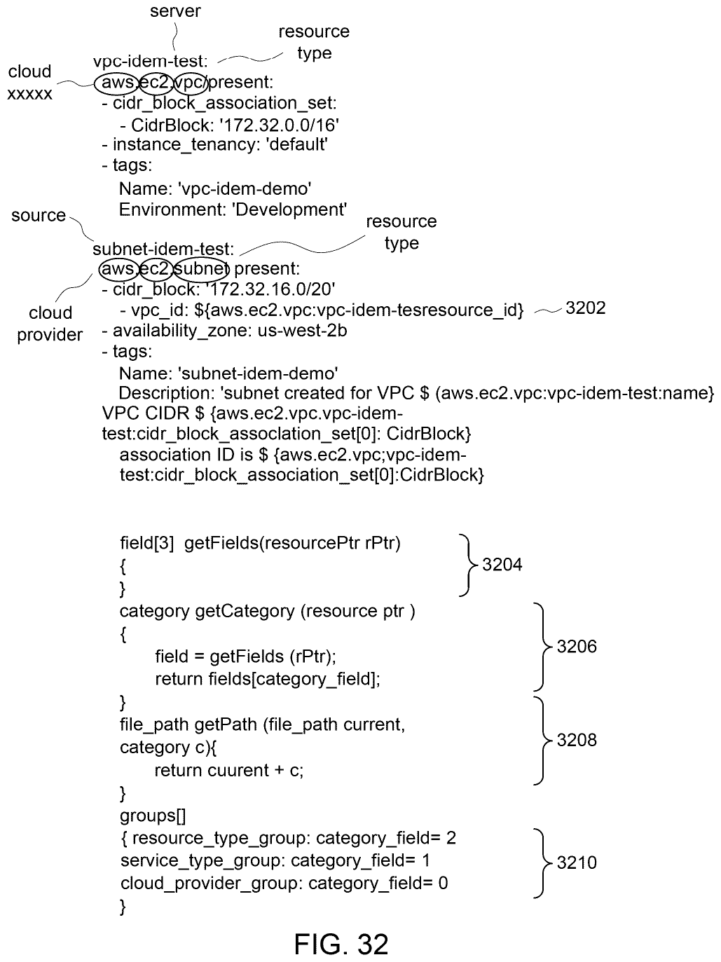

FIG. 32 illustrates a basis for resource-descriptor grouping according to the automated-segregator implementation discussed above with reference to FIGS. 27A-29G. Using a portion of an SLS data file 3202, values for the three categories cloud provider, service, and resource type are extracted from the cloud-provider/service/resource-type tuples in the second lines of two different resource specifications, as indicated by the category labels and curved lines in FIG. 32. A getFields function declaration 3204 represents a function that retrieves category values from cloud-provider/service/resource-type tuples in resource descriptors and places them in an array. The group member function getCategory 3206 is implemented by using the getFields function to extract the category values from a resource descriptor and then returning the value for a specific category indexed by the constant or variable category_fields. The group member function getPath 3208 appends a category value or character string based on a category value to a current file path. Finally, three different groups corresponding to the three different categories resource type, service type, and cloud provider are defined by defining specific values for the category_field constant or variable 3210. Using implementations and the automated-segregator implementation discussed above with reference to FIGS. 27A-29G, the various example resource-descriptor groupings shown in FIG. 31, and many additional resource-descriptor groupings, can be produced from arbitrary input SLS data files.

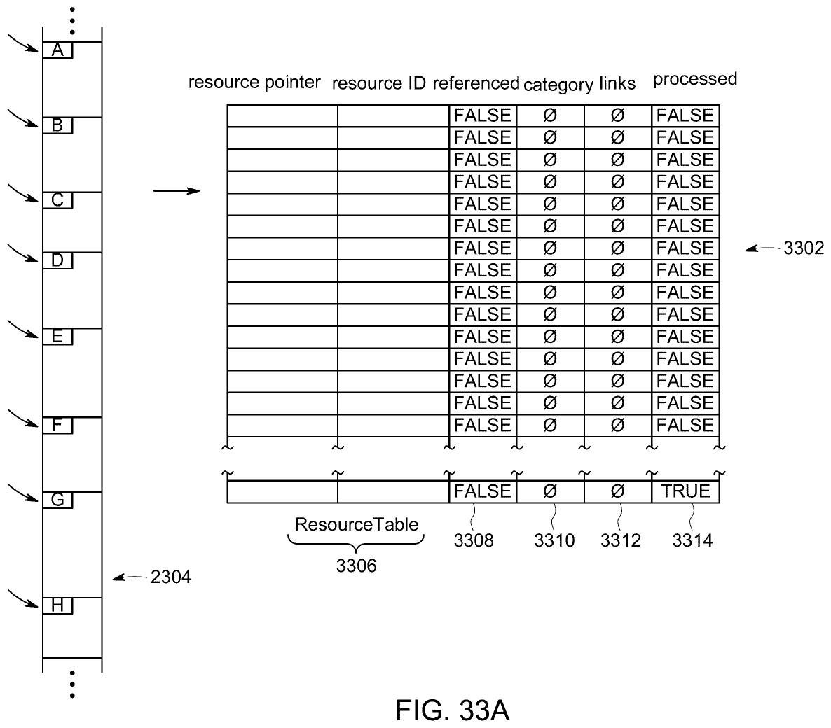

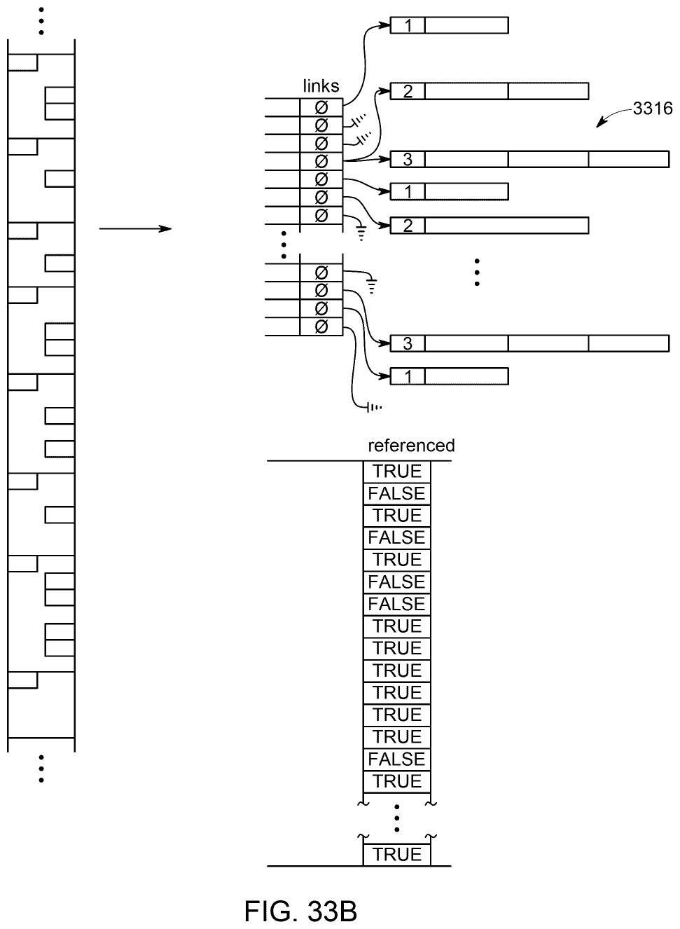

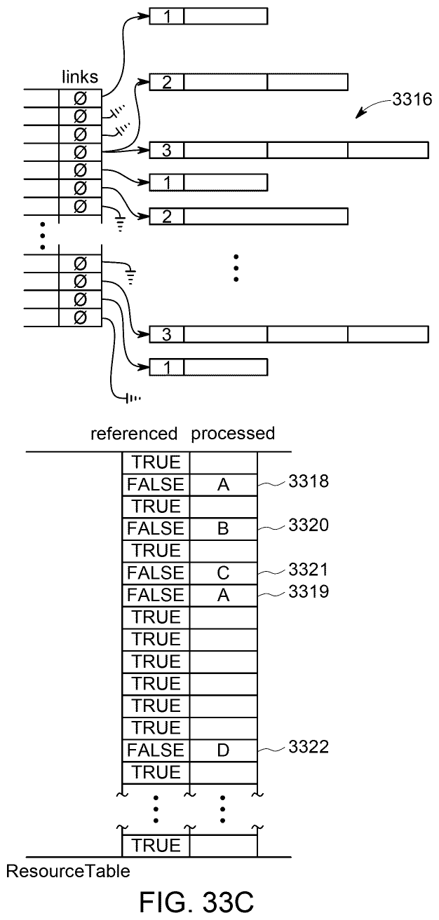

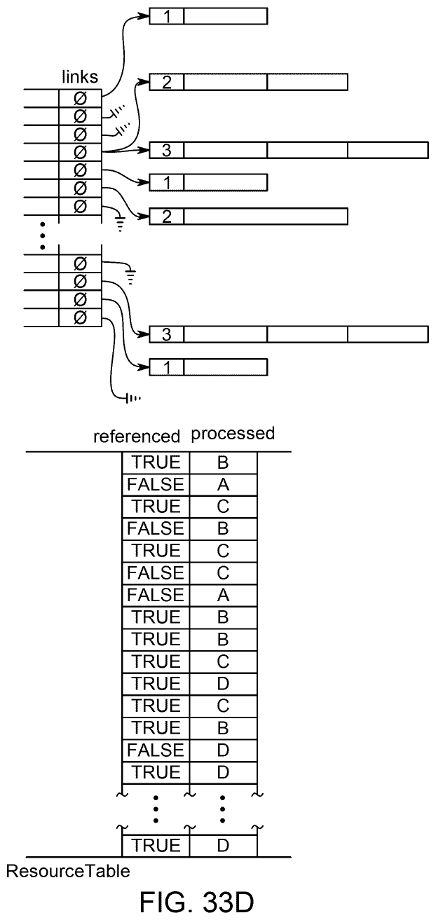

FIGS. 33A-D illustrate steps carried out to group resource descriptors by a category corresponding to membership in acyclic graphs obtained using resource-descriptor references within resource descriptors, as discussed with reference to FIG. 24. Each different acyclic graph corresponds to a different category value, and the category value associated with a resource descriptor is the category value corresponding to the acyclic graph to which the resource descriptor belongs. As shown in FIG. 33A, a first step involves construction of a resource table 3302 used for storing information acquired from the resource descriptors within the in-memory data structure 3304. Each resource descriptor is referenced by a resource pointer and each resource descriptor contains a resource ID. The resource table includes an entry for each resource descriptor. Each entry contains six different fields corresponding to the columns of the resource table. The first two fields 3306 contain the resource pointer to, and a resource ID contained in, a resource descriptor. A third field referenced 3308 contains the Boolean value indicating whether or not the resource descriptor is referenced by a different resource descriptor. A fourth field category 3310 contains a category value for the resource descriptor indicating the acyclic graph, if any, that contains the resource descriptor. A fifth field links 3312 contains pointers to lists of resource IDs, resource pointers, or indexes of resource-table entries corresponding to the external resource descriptors referenced from within the resource descriptor. A sixth field processed 3314 contains a Boolean value that indicates whether or not the descriptor has been fully processed by the process for assigning acyclic-graph membership category values to the different resource descriptors. The resource table is initialized as indicated in FIG. 33A, with all the values of the referenced and processed fields set to FALSE and all the values of the category and links fields set to NULL.

FIG. 33B illustrates a second step carried out to group resource descriptors by a category corresponding to membership in acyclic graphs obtained by internal resource descriptors, as discussed with reference to FIG. 24. In this second step, each of the resource descriptors is considered. When the resource descriptor includes references to other resource descriptors, a list of resource IDs, resource pointers, or indexes of resource-table entries corresponding to the referenced resource descriptors, such as list 3316, is allocated and referenced from the links field of the resource table-entry for the resource descriptor. Each list of resource IDs, resource pointers, or indexes of resource-table entries includes an indication of the number of entries in the list. At the same time, the Boolean value in the referenced field for each resource descriptor is set to TRUE when the resource descriptor is referenced from another resource descriptor.

FIG. 33C illustrates a third step carried out to group resource descriptors by a category corresponding to membership in acyclic graphs represented by resource pointers in resource descriptors, as discussed with reference to FIG. 24. In this step, each resource-descriptor entry in the resource table is considered. When the value of the referenced field is FALSE for a resource-descriptor entry, the resource descriptor is either the root node in an acyclic graph, when the links field is non-NULL, or does not belong to any acyclic graph when the links field is NULL. In this example, the category value A is assigned to those resource descriptors that do not belong to any acyclic graph. Different categories are assigned to each of the resource descriptors that corresponds to the root node of an acyclic graph. In the example shown in FIG. 33C, resource-table entries 3318-3319 correspond to resource descriptors that do not belong to any acyclic graph and resource-table entries 3320-3322 correspond to resource descriptors that each corresponds to root nodes of an acyclic graph.

FIG. 33D illustrates a fourth step carried out to group resource descriptors by a category corresponding to membership in acyclic graphs represented by resource pointers in resource descriptors, as discussed with reference to FIG. 24. In this fourth step, all of the resource-table entries that have not yet been processed are iteratively considered in order to assign category values to each remaining resource-table entry. A resource descriptor referenced by a different resource descriptor for which a category has been assigned is assigned to the category assigned to the referencing different resource descriptor. Upon completion of this fourth step, the information contained in the resource table provides a map of resource pointers and resource IDs to category values for the category related to membership in acyclic graphs.

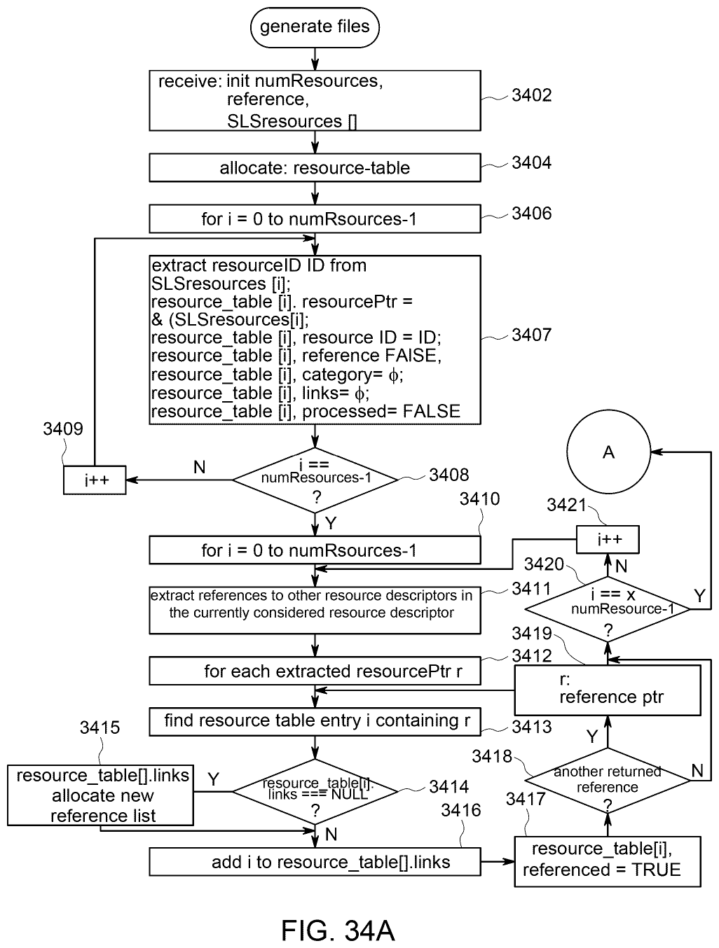

FIGS. 34A-B provide control-flow diagrams for the group member function init that initializes a group instance to provide acyclic-graph-membership-category values via the group member function getCategory. Initialization of the group instance carries out the process discussed above with reference to FIGS. 33A-D. In step 3402, the function init receives an indication of the number of resources in the in-memory data structure along with a reference to the in-memory data structure. In step 3404, the function init allocates a resource table. In the for-loop of steps 3406-3409, the function init initializes the resource table as discussed above with reference to FIG. 33A. Thefor-loop of steps 3410-3421 considers each resource descriptor in the in-memory data structure. In step 3411, the function init extracts references to other resource descriptors in the currently considered resource descriptor and, in the inner for-loop of steps 3412-3419, adds the resource IDs, resource pointers, or resource-table indexes corresponding to the referenced resource descriptors to a list of resource IDs, resource pointers, or resource-table indexes that is referenced from the links field of the resource-table entry corresponding to the currently considered resource descriptor. Turning to FIG. 34B, a local variable nxtCategory is set, in step 3430, to a first category value that follows the category value A assigned to resource descriptors that are not members of an acyclic graph. Then, in the for-loop of steps 3432-3438, each resource-table entry is considered. When the referenced field of the currently considered resource-table entry is FALSE, as determined in step 3433, and when the links field is NULL, as determined in step 3434, the resource descriptor is assigned category value A, in step 3435, and the processed field is set to TRUE. When the referenced field of the currently considered resource-table entry is FALSE, as determined in step 3433, and when the links field is not NULL, as determined in step 3434, the resource descriptor is assigned the category value contained in local variable nxtCategory and local variable nxtCategory is set to a following category value, in step 3436. In step 3440, a local variable change is set to FALSE. Then, in the for-loop of steps 3442-3451, all of the resource-table entries are again considered. When the processed field of the currently considered resource-table entry is TRUE, as determined in step 3443, control flows to step 3450, short-circuiting the current iteration of the for-loop of steps 3422-3451. When the category field of the currently considered resource-table entry is NULL, as determined in step 3444, control flows to step 3450, short-circuiting the current iteration of the for-loop of steps 3422-3451. Otherwise, the innerfor-loop of steps 3445-3448 considers each resource-table entry corresponding to a resource ID, resource pointer, or resource-table index in the list of resource IDs, resource pointers, or resource-table indexes referenced by the links field of the currently considered resource-table entry. The category value for the currently considered resource-table entry in the inner for-loop of steps 3445-3448 is set to the category value for the currently considered resource-table entry in the outerfor-loop of steps 3422-3451 and the local variable change is set to TRUE, in step 3446. Following completion of the inner for-loop of steps 3445-3448, the processed field of the currently considered resource-table entry in the outer for-loop of steps 3422-3451 is set to TRUE and the list of resource IDs, resource pointers, or resource-table indexes referenced by the links field of the resource-table entry is deallocated. Following completion of the outer for-loop of steps 3422-3451, the function init determines whether the local variable change is TRUE. If so, control returns to step 3444 another execution of the outer for-loop of steps 3422-3451 to assign more category values to resource descriptors. Otherwise, the function init returns.

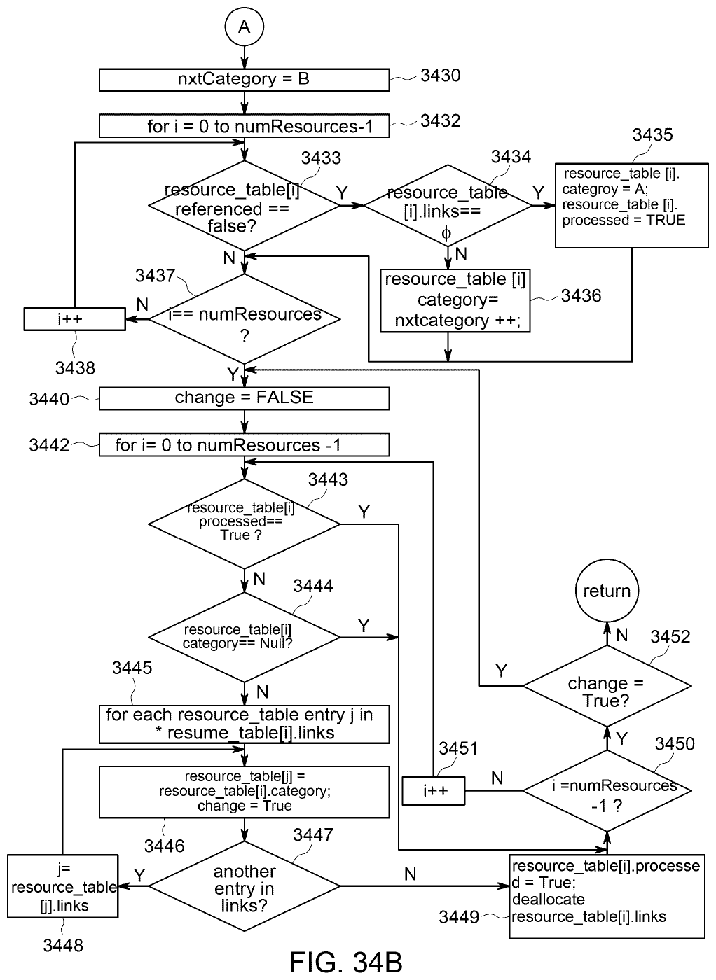

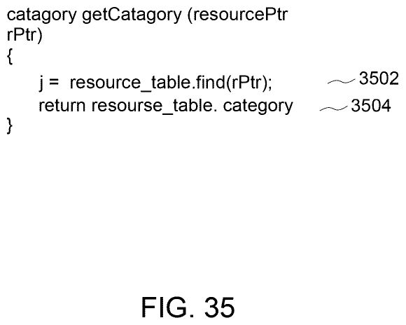

FIG. 35 shows implementation of the group member function getCategory for a group that returns category values for the acyclic-graph-membership category. A local variable j is set to the index of an entry in the resource table corresponding to a resource descriptor referenced by the resource-pointer argument 3502 and the function getCategory returns the category value stored in the category field of that resource-table entry 3504.

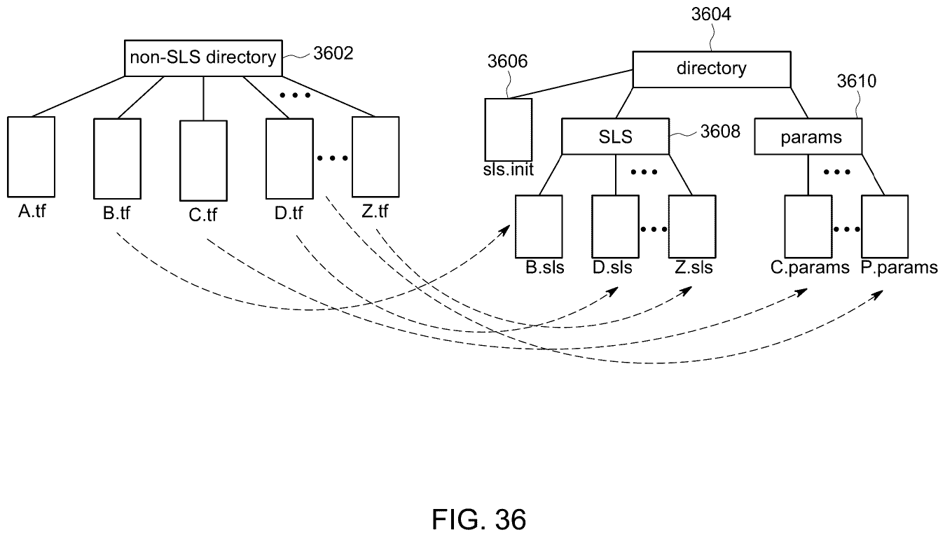

FIG. 36 illustrates a second mode of operation of the currently disclosed automated segregator. In this mode of operation, the automated segregator is provided with a file-system directory 3602 containing non-SLS specification-and-configuration files which, in the current example, have file names with the extension “.tf.” The automated segregator then creates a new directory 3604 that contains an sls.init file 3606, an SLS subdirectory 3608, and a params subdirectory 3610. The automated segregator then translates resource descriptors and variable descriptors in the non-SLS specification-and-configuration files into SLS resource descriptors added to SLS data files in the SLS subdirectory and parameter files in the params subdirectory. This provides a first step in organizing translated non-SLS specification-and-configuration information into a corresponding set of SLS data files and parameter files to facilitate migration from a non-SLS IaC to an Idem service or system.

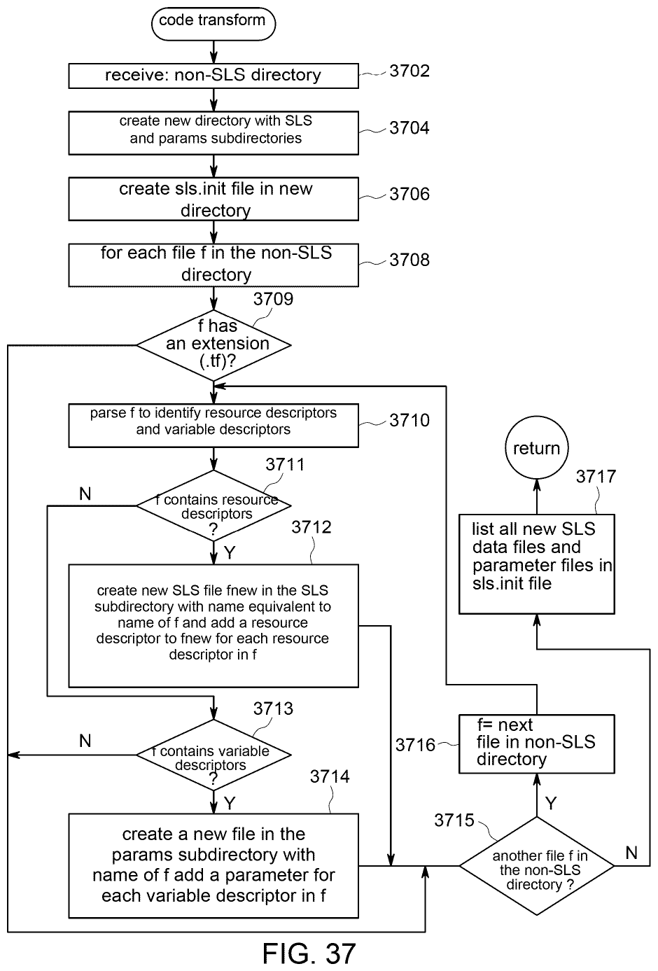

FIG. 37 provides a control-flow diagram for a routine “code transform” which represents the second mode of operation of the currently disclosed automated segregator. In step 3702, the routine “code transform” receives the non-SLS directory. In step 3704, the routine “code transform” creates the corresponding new directory with SLS and params subdirectories. In step 3706, the routine “code transform” creates the sls.init file in the new directory. In the for-loop of steps 3708-3716, each file f in the non-SLS directory is considered. When the currently considered file f does not have the .tf extension, as determined in step 3709, execution of the current iteration of the for-loop of steps 3708-3716 is short circuited, with control flowing to step 3715. In step 3710, the currently considered file f is parsed to identify resource descriptors and variable descriptors. When the currently considered file f contains resource descriptors, as determined in step 3711, a corresponding SLS data file fnew is created with a name equivalent to the name of the currently considered file f and a resource descriptor is added to fnew for each resource descriptor in f. In certain implementations, only those resource descriptors in f that correspond to resource descriptors in the in-memory data structure generated from one or more SLS data files are translated into SLS resource descriptors and added to fnew. Otherwise, when f contains variable descriptors, as determined in step 3713, the variable descriptors are translated into parameter declarations that are added to a new file in the params subdirectory, in step 3714. When there is another file fin the non-SLS directory, as determined in step 3715, another iteration of the for-loop of steps 3708-3716 is carried out. Otherwise, in step 3717, all of the new SLS data files and parameter files are listed in the sls.init file.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters.

What is claimed is:

1. An automated infrastructure-as-code cloud-infrastructure manager comprising:
one or more computer systems, each containing one or more processors, one or more memories, and one or more data-storage devices; and
processor instructions, stored in one or more of the one or more memories that, when executed by one or more of the one or more processors, control the one or more computer systems to implement the automated infrastructure-as-code cloud-infrastructure manager, the infrastructure-as-code cloud-infrastructure-manager including
a management interface that receives cloud-infrastructure-management commands and requests,
an execution engine that executes the received cloud-infrastructure-management commands and requests, and
an automated segregator that segregates resource descriptors into category-associated resource-descriptor groups and stores the specifications for the resource descriptors of each resource-descriptor group into a category-associated file.

2. The automated infrastructure-as-code cloud-infrastructure manager of claim 1 wherein the automated infrastructure-as-code cloud-infrastructure manager instantiates and configures cloud infrastructure according to one or more specification-and-configuration data files that include resource descriptors.

3. The automated infrastructure-as-code cloud-infrastructure manager of claim 2 wherein a resource descriptor includes:
a resource ID;
a cloud-provider/service/resource-type tuple containing three fields; and
attributes that contain values.

4. The automated infrastructure-as-code cloud-infrastructure manager of claim 3 wherein the automated segregator segregates resource descriptors into category-associated resource-descriptor groups by:
extracting resource descriptors from one or more specification-and-configuration data files and storing the resource descriptors in an in-memory data structure;
for each of one or more categories, determining a category value for each resource descriptor;
grouping the resource descriptors into category-associated resource-descriptor groups; and
for each category-associated resource-descriptor group,
storing the category-associated resource-descriptor group in a file having a file-system pathname that includes a filename and that incorporates indications of the one or more category values associated with each of the resource descriptors of the resource-descriptor group stored in the file.

5. The automated infrastructure-as-code cloud-infrastructure manager of claim 4 wherein determining a category value for each resource descriptor further comprises:
selecting values from one or more fields and attributes in the resource descriptor; and
generating a category value from the selected values.

6. The automated infrastructure-as-code cloud-infrastructure manager of claim 5
wherein a category value for a cloud-provider category is determined for a resource descriptor by
extracting the contents of a field in the cloud-provider/service/resource-type tuple corresponding to a cloud-provider, and
either using the extracted content as the category value or using the extracted content to generate the category value;
wherein a category value for a service category is determined for a resource descriptor by
extracting the contents of a field in the cloud-provider/service/resource-type tuple corresponding to a service, and
either using the extracted content as the category value or using the extracted content to generate the category value; and
wherein a category value for a service category is determined for a resource descriptor by
extracting the contents of a field in the cloud-provider/service/resource-type tuple corresponding to a service, and
either using the extracted content as the category value or using the extracted content to generate the category value.

7. The automated infrastructure-as-code cloud-infrastructure manager of claim 4
wherein a category value for a cloud-provider category is determined for a resource descriptor by
determining an acyclic graph, with edges corresponding to references to resource descriptors contained in one or more field and/or attribute values of the resource descriptor and nodes corresponding to resource descriptors, that includes the resource descriptor as a node,
generating a category value corresponding to the acyclic graph.

8. The automated infrastructure-as-code cloud-infrastructure manager of claim 4 wherein grouping the resource descriptors into category-associated resource-descriptor groups further comprises:
generating a data structure that includes
one level for each of the one or more categories,
multiple lists of resource-descriptor IDs, resource-descriptor pointers, or indexes, each list indicating the set of resources descriptors comprising a resource-descriptor group, and
for each of the multiple lists, a path of data-structure components that includes a data-structure component for each level, wherein the category values associated with the data-structure components in the path comprising an ordered set of category values uniquely designating a resource-descriptor group.

9. The automated infrastructure-as-code cloud-infrastructure manager of claim 8 wherein storing each category-associated resource-descriptor group in a file having a file-system pathname that includes a filename further comprises:
for each of the multiple lists,
using the ordered set of category values uniquely designating a resource-descriptor group corresponding to the list to construct a file-system path name, including a file name,
creating the file specified by the file-system path name and any subdirectories specified in the path name not already created, and
storing each resource descriptor specified by a resource-descriptor ID, resource-descriptor pointer, or index in the list in the file.

10. The automated infrastructure-as-code cloud-infrastructure manager of claim 4 further comprising:
sorting the resource-descriptors in each file using a resource-descriptor comparison routine.

11. The automated infrastructure-as-code cloud-infrastructure manager of claim 1 wherein the automated segregator provides a second mode of operation in which the automated segregator
receives a directory containing specification-and-configuration files used by a first infrastructure-as-code cloud-infrastructure manager,
creates a new directory containing specification-and-configuration files used by a second infrastructure-as-code cloud-infrastructure manager,
transforms resource descriptors in the specification-and-configuration files used by the first infrastructure-as-code cloud-infrastructure manager to resource descriptors useable by the second infrastructure-as-code cloud-infrastructure manager, and
transfers the transformed resource descriptors to specification-and-configuration files used by the second infrastructure-as-code cloud-infrastructure manager.

12. The automated infrastructure-as-code cloud-infrastructure manager of claim 11 wherein the specification-and-configuration file used by the second infrastructure-as-code cloud-infrastructure manager that contains a particular resource descriptor has a file name identical to, or derived from, the filename of the specification-and-configuration file used by the first infrastructure-as-code cloud-infrastructure manager that contains a resource descriptor transformed to produce the particular resource descriptor.

13. A method that that segregates resource descriptors into category-associated resource-descriptor groups and stores specifications for the resource descriptors of each resource-descriptor group into a category-associated file, the method carried out by an automated segregator within an automated infrastructure-as-code cloud-infrastructure manager that instantiates and configures cloud infrastructure according to one or more specification-and-configuration data files that include resource descriptors, each resource descriptor including a resource ID, a cloud-provider/service/resource-type tuple containing three fields, and attributes that contains values, the method comprising:
extracting resource descriptors from one or more specification-and-configuration data files and storing the resource descriptors in an in-memory data structure;
for each of one or more categories, determining a category value for each resource descriptor;
grouping the resource descriptors into category-associated resource-descriptor groups; and
for each category-associated resource-descriptor group,
storing the category-associated resource-descriptor group in a file having a file-system pathname that includes a filename and that incorporates indications of the one or more category values associated with each of the resource descriptors of the resource-descriptor group stored in the file.

14. The method of claim 13
wherein a category value for a cloud-provider category is determined for a resource descriptor by
determining an acyclic graph, with edges corresponding to references to resource descriptors contained in one or more field and/or attribute values of the resource descriptor and nodes corresponding to resource descriptors, that includes the resource descriptor as a node,
generating a category value corresponding to the acyclic graph.

15. The method of claim 13 wherein determining a category value for each resource descriptor further comprises:
selecting values from one or more fields and attributes in the resource descriptor; and
generating a category value from the selected values.

16. The method of claim 15
wherein a category value for a cloud-provider category is determined for a resource descriptor by
extracting the contents of a field in the cloud-provider/service/resource-type tuple corresponding to a cloud-provider, and
either using the extracted content as the category value or using the extracted content to generate the category value;
wherein a category value for a service category is determined for a resource descriptor by
extracting the contents of a field in the cloud-provider/service/resource-type tuple corresponding to a service, and
either using the extracted content as the category value or using the extracted content to generate the category value; and
wherein a category value for a service category is determined for a resource descriptor by
extracting the contents of a field in the cloud-provider/service/resource-type tuple corresponding to a service, and
either using the extracted content as the category value or using the extracted content to generate the category value.

17. The method of claim 13 wherein grouping the resource descriptors into category-associated resource-descriptor groups further comprises:
generating a data structure that includes
one level for each of the one or more categories,
multiple lists of resource-descriptor IDs, resource-descriptor pointers, or indexes, each list indicating the set of resources descriptors comprising a resource-descriptor group, and
for each of the multiple lists, a path of data-structure components that includes a data-structure component for each level, wherein the category values associated with the data-structure components in the path comprising an ordered set of category values uniquely designating a resource-descriptor group.

18. The method of claim 17 wherein storing each category-associated resource-descriptor group in a file having a file-system pathname that includes a filename further comprises:
for each of the multiple lists,
using the ordered set of category values uniquely designating a resource-descriptor group corresponding to the list to construct a file-system path name, including a file name,
creating the file specified by the file-system path name and any subdirectories specified in the path name not already created, and
storing each resource descriptor specified by a resource-descriptor ID, resource-descriptor pointer, or index in the list in the file.

19. The method of claim 13 further comprising:
sorting the resource-descriptors in each file using a resource-descriptor comparison routine.

20. A physical data-storage device encoded with processor instructions that, when executed by one or more processors within one or more computer systems, each containing one or more processors, one or more memories, and one or more data-storage devices, control the one or more computer systems to implement an automated infrastructure-as-code cloud-infrastructure manager, the automated infrastructure-as-code cloud-infrastructure manager comprising:
a management interface that receives cloud-infrastructure-management commands and requests,
an execution engine that executes the received cloud-infrastructure-management commands and requests, and
an automated segregator that segregates resource descriptors into category-associated resource-descriptor groups and stores the specifications for the resource descriptors of each resource-descriptor group into a category-associated file.
